(19) United States
(12) Patent Application Publication
(10) Pub. No.: US 2026/0173149 A1
(43) Pub. Date: Jun. 18, 2026

(54) RANDOM ACCESS MESSAGE COLLISION RESOLUTION USING CYCLIC SHIFT RANGES

(71) Applicant: QUALCOMM Incorporated, San Diego, CA (US)

(72) Inventors: Raviteja PATCHAVA, San Diego, CA (US); Jing SUN, San Diego, CA (US); Jing JIANG, San Diego, CA (US)

(21) Appl. No.: 18/985,782

(22) Filed: Dec. 18, 2024

(51) Int. Cl. H04W 74/0833; H04L 27/26

(52) U.S. Cl. CPC H04W 74/0833; H04L 27/2605

(57) ABSTRACT

Various aspects of the present disclosure generally relate to wireless communication. In some aspects, a network node may receive, from a first user equipment (UE), a first random access preamble including a first cyclic shift, and from a second UE, a second random access preamble including a second cyclic shift. The network node may transmit, to the first UE, a first random access response message including a first cyclic shift range in accordance with detecting a first communication path associated with the first cyclic shift and a second communication path associated with the second cyclic shift. The network node may receive a random access message from the first UE according to the first cyclic shift range. The network node may transmit, to the second UE, a second random access response message including a second cyclic shift range in accordance with receiving the random access message. Numerous other aspects are described.

### FIELD OF THE DISCLOSURE

Aspects of the present disclosure generally relate to wireless communication and specifically relate to techniques, apparatuses, and methods associated with random access message collision resolution using cyclic shift ranges.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

A wireless communications system may include one or more network nodes, each supporting wireless communication for communication devices, which may be known as user equipments (UEs). In some wireless communications systems, a UE may establish a connection with a network node by performing a random access procedure with the network node. The UE may transmit, and the network node may receive, via a physical random access channel, a first random access message (e.g., a preamble including, or associated with, a cyclic shift and/or a root sequence) to the network node to initiate the random access procedure. The network node and the UE may exchange one or more additional random access messages to establish the connection.

### SUMMARY

Some aspects described herein relate to an apparatus for wireless communication at a network node. The apparatus may include one or more memories and one or more processors coupled to the one or more memories. The one or more processors may be configured to receive, from a first user equipment (UE), a first random access preamble including a first cyclic shift, and from a second UE, a second random access preamble including a second cyclic shift. The one or more processors may be configured to transmit, to the first UE, a first random access response message including a first cyclic shift range in accordance with detecting a first communication path associated with the first cyclic shift and a second communication path associated with the second cyclic shift. The one or more processors may be configured to receive a random access message from the first UE in accordance with the first cyclic shift range. The one or more processors may be configured to transmit, to the second UE, a second random access response message including a second cyclic shift range in accordance with receiving the random access message from the first UE.

Some aspects described herein relate to an apparatus for wireless communication at a UE. The apparatus may include one or more memories and one or more processors coupled to the one or more memories. The one or more processors may be configured to transmit, to a network node, a random access preamble including a cyclic shift. The one or more processors may be configured to receive, from the network node, a random access response message indicating a cyclic shift range associated with a communication path of the UE. The one or more processors may be configured to transmit a random access message in accordance with the cyclic shift range.

Some aspects described herein relate to a method of wireless communication performed by a network node. The method may include receiving, from a first UE, a first random access preamble including a first cyclic shift, and from a second UE, a second random access preamble including a second cyclic shift. The method may include transmitting, to the first UE, a first random access response message including a first cyclic shift range in accordance with detecting a first communication path associated with the first cyclic shift and a second communication path associated with the second cyclic shift. The method may include receiving a random access message from the first UE in accordance with the first cyclic shift range. The method may include transmitting, to the second UE, a second random access response message including a second cyclic shift range in accordance with receiving the random access message from the first UE.

Some aspects described herein relate to a method of wireless communication performed by a UE. The method may include transmitting, to a network node, a random access preamble including a cyclic shift. The method may include receiving, from the network node, a random access response message indicating a cyclic shift range associated with a communication path of the UE. The method may include transmitting a random access message in accordance with the cyclic shift range.

Some aspects described herein relate to a non-transitory computer-readable medium that stores a set of instructions for wireless communication by a network node. The set of instructions, when executed by one or more processors of the network node, may cause the network node to receive, from a first UE, a first random access preamble including a first cyclic shift, and from a second UE, a second random access preamble including a second cyclic shift. The set of instructions, when executed by one or more processors of the network node, may cause the network node to transmit, to the first UE, a first random access response message including a first cyclic shift range in accordance with detecting a first communication path associated with the first cyclic shift and a second communication path associated with the second cyclic shift. The set of instructions, when executed by one or more processors of the network node, may cause the network node to receive a random access message from the first UE in accordance with the first cyclic shift range. The set of instructions, when executed by one or more processors of the network node, may cause the network node to transmit, to the second UE, a second random access response message including a second cyclic shift range in accordance with receiving the random access message from the first UE.

Some aspects described herein relate to a non-transitory computer-readable medium that stores a set of instructions for wireless communication by a UE. The set of instructions, when executed by one or more processors of the UE, may cause the UE to transmit, to a network node, a random access preamble including a cyclic shift. The set of instructions, when executed by one or more processors of the UE, may cause the UE to receive, from the network node, a random access response message indicating a cyclic shift range associated with a communication path of the UE. The set of instructions, when executed by one or more processors of the UE, may cause the UE to transmit a random access message in accordance with the cyclic shift range.

Some aspects described herein relate to an apparatus for wireless communication. The apparatus may include means for receiving, from a first UE, a first random access preamble including a first cyclic shift, and from a second UE, a second random access preamble including a second cyclic shift. The apparatus may include means for transmitting, to the first UE, a first random access response message including a first cyclic shift range in accordance with detecting a first communication path associated with the first cyclic shift and a second communication path associated with the second cyclic shift. The apparatus may include means for receiving a random access message from the first UE in accordance with the first cyclic shift range. The apparatus may include means for transmitting, to the second UE, a second random access response message including a second cyclic shift range in accordance with receiving the random access message from the first UE.

Some aspects described herein relate to an apparatus for wireless communication. The apparatus may include means for transmitting, to a network node, a random access preamble including a cyclic shift. The apparatus may include means for receiving, from the network node, a random access response message indicating a cyclic shift range associated with a communication path of the apparatus. The apparatus may include means for transmitting a random access message in accordance with the cyclic shift range.

Aspects of the present disclosure may generally be implemented by or as a method, apparatus, system, computer program product, non-transitory computer-readable medium, user equipment, base station, network node, network node, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example including aspects of a two-step random access procedure and a four-step random access procedure, in accordance with the present disclosure.

FIG. 4 is a diagram illustrating an example of a random access message collision, in accordance with the present disclosure.

FIG. 5 is a diagram illustrating an example of random access message collision resolution, in accordance with the present disclosure.

FIG. 6A is a diagram illustrating an example of multipath detection, in accordance with the present disclosure.

FIG. 6B is a diagram illustrating an example of multipath collision, in accordance with the present disclosure.

FIG. 7 is a diagram illustrating an example of collision detection for extra-provisioned cyclic shifts, in accordance with the present disclosure.

FIG. 8 is a diagram of an example associated with random access message collision resolution using cyclic shift ranges, in accordance with the present disclosure.

FIG. 9 is a diagram illustrating an example associated with cyclic shift ranges, in accordance with the present disclosure.

FIG. 10 is a diagram illustrating an example associated with a timeline and sequential random access message transmission, in accordance with the present disclosure.

FIG. 11A is a diagram illustrating an example associated with random access message collision detection, in accordance with the present disclosure.

FIG. 11B is a diagram illustrating an example associated with random access message collision resolution, in accordance with the present disclosure.

FIG. 12A is a diagram illustrating an example associated with random access message collision detection, in accordance with the present disclosure.

FIG. 12B is a diagram illustrating an example associated with random access message collision resolution, in accordance with the present disclosure.

FIG. 13A is a diagram illustrating an example associated with random access message collision detection, in accordance with the present disclosure.

FIG. 13B is a diagram illustrating an example associated with random access message collision resolution, in accordance with the present disclosure.

FIG. 14 is a diagram illustrating an example process performed, for example, at a network node or an apparatus of a network node, in accordance with the present disclosure.

FIG. 15 is a diagram illustrating an example process performed, for example, at a UE or an apparatus of a UE, in accordance with the present disclosure.

FIG. 16 is a diagram of an example apparatus for wireless communication, in accordance with the present disclosure.

FIG. 17 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some wireless communication networks, a wireless communication connection between a network node and a user equipment (UE) in a cell may be established using a random access procedure. For example, a UE may transmit a random access preamble (e.g., a physical random access channel (PRACH) preamble) to a network node that may initiate the random access procedure. The preamble may include or be an example of a preamble sequence, which may also be referred to herein as a PRACH sequence, a root sequence, or the like. To generate the preamble, the UE may select a preamble sequence from a set of preamble sequences configured for random access procedures. The UE may generate the preamble based on the selected preamble sequence and a selected cyclic shift from a set of cyclic shifts. The network node may distinguish between preambles sent from multiple UEs according to the set of preamble sequences and the set of cyclic shifts, as each UE transmitting a preamble may select a different preamble sequence and/or cyclic shift. For example, the network node may detect that received preambles originated from different UEs based on each preamble being associated with a different preamble sequence. Additionally, or alternatively, each preamble may have a different arrival time at the network node according to the corresponding cyclic shift. Thus, even if two UEs select a same preamble sequence, the network node may detect that the received preambles originated from different UEs based on each preamble having a different arrival time at the network node. If multiple UEs select the same preamble, the network node may transmit a response message allocating resources for another random access message to each UE using the same preamble (e.g., a third message (msg3) of a four-step random access procedure), resulting in a collision due to multiple UEs transmitting via the same allocated resources.

In some examples, the set of preamble sequences may be assigned on a per-cell or per-network node basis. For example, a set of preamble sequences may include a quantity of preamble sequences such that it is unlikely that two UEs in a cell select a same preamble sequence at a same or similar time. A set of cyclic shifts may be associated with a cyclic shift step size (e.g., a spacing between each cyclic shift in the set of cyclic shifts) that avoids overlap in cyclic shifts detected by the network node, for example, based on a size of the cell and a corresponding propagation delay. In some scenarios, however, two or more different UEs may initiate a random access procedure by transmitting the same preamble sequence at the same or similar time. For instance, the quantity of preamble sequences may be limited and may not be sufficient for a cell including a large quantity of UEs. As another example, in smaller cells, if two UEs select a same cyclic shift for respective preambles, the corresponding propagation delay may not be sufficient to provide a distinction between the arrival times of preambles received at the network node, and the network node may detect a single communication path.

In such scenarios, the network node may be unable to distinguish between the two UEs based on preamble sequence or time of arrival. For example, when multiple preambles have a same or similar arrival time at the network node—particularly if the preambles are associated with a same preamble sequence or cyclic shift—the network node may be unable to detect that separate preambles have been received, such that the random access procedure may be successful for one of the UEs as described above. To resolve the conflict, one of the UEs may reinitiate the random access procedure, thereby using more resources and increasing the latency associated with establishing the connection with the network node. Additionally or alternatively, the UE may wait for a contention resolution message, and eventually may restart the random access procedure, resulting in extended delays and system latency. Moreover, when the quantity of preamble sequences is limited, the likelihood that multiple UEs select a same preamble sequence may increase as the quantity of UEs in the cell increases.

Some techniques may support cyclic shifts for transmission of preambles in random access procedures, which may enable the network node to separate received preambles even when the preambles have a same or similar arrival time at the network node. For example, the UE may transmit a random access preamble according to a cyclic shift from a first set of cyclic shifts associated with a cyclic shift step size that is less than a round trip time (RTT) (e.g., a maximum RTT) of a cell associated with the UE. In some examples, the UE may generate the first set of cyclic shifts from a second set of cyclic shifts (e.g., nominal cyclic shifts having a second step size greater than or equal to the RTT) and a set of cyclic shift offsets, where the set of cyclic shift offsets is associated with an offset step size (e.g., has a regular or consistent offset step size) that is less than the RTT of a serving cell of the UE. The cyclic shift offset may enable a receiving network node to distinguish between random access preambles communicated by multiple different UEs (e.g., even if two (or more) UEs select a same cyclic shift). Additionally, or alternatively, the cyclic shift step size of the first set of cyclic shifts may be a consistent (e.g., regular) step size that is less than the RTT, which may provide a greater number of cyclic shifts for the first set of cyclic shifts (e.g., compared to a set of cyclic shifts having a step size that is greater than or equal to the RTT).

However, because the difference between the transmitted cyclic shifts may be smaller than the RTT, the network node may encounter issues identifying a UE based on the timing and/or identifying a collision between multiple UEs. Further, the network node may be unable to detect a collision based on the communication paths being separated by less than RTT because there may be scenarios in which even the detected paths at the network node are within an RTT duration (e.g., a maximum RTT duration), and while the UEs may be able to find a timing that seemingly avoids collision, the network node may not accurately detect the collision.

Various aspects relate generally to random access response message transmission indicating a range of cyclic shifts for communication path detection when implementing extra-provisioned cyclic shifts. Some aspects more specifically relate to a network node sequentially transmitting a range of cyclic shifts via one or more random access response messages. In some aspects, a network node may detect a first communication path that is transmitted by a first UE using a first cyclic shift and/or may detect a second communication path that is transmitted by a second UE using a second cyclic shift. The network node may detect a collision between the first communication path and the second communication path and may group the detected communication paths based on detecting the collision. The network node may calculate one or more probabilities that a collision will not occur for each detected communication path.

The network node may transmit, to the first UE and the second UE, a msg2 indicating a cyclic shift range for the first communication path. In some aspects, the msg2 may include a resource allocation for a msg3. The first UE and the second UE may each decode the msg2. The first UE may identify that the first cyclic shift is within the cyclic shift range. As a result, the first UE may transmit a msg3 via the msg2 resource allocation. The second UE may identify that the second cyclic shift is not within the cyclic shift range and thus may refrain from transmitting a msg3 via the msg2 resource allocation.

The network node may receive the msg3 from the first UE and may thus identify that the first communication path is associated with the first UE. The network node may transmit a second msg2 to the second UE indicating a cyclic shift range for the second communication path. In some aspects, the msg2 may include a resource allocation for a second msg3. The second UE may identify that second cyclic shift is within the cyclic shift range. As a result, the second UE may transmit a msg3 via the second msg2 resource allocation.

Particular aspects of the subject matter described in this disclosure can be implemented to realize one or more of the following potential advantages. In some aspects, the network node sequentially transmitting a range of cyclic shifts via one or more random access response messages may improve the UE delay, when compared to multipath detect and collision resolution as described above, and may decrease resource consumption compared to random access procedures using extra-provisioned cyclic shifts. For example, by the network node transmitting sequential random access response messages, the described techniques can be used to avoid initiating a collision resolution procedure with each colliding UE, which may conserve resources and time for at least one colliding UE. By the network node transmitting the first cyclic shift range and/or the second cyclic shift range to assist the UEs in identifying when to transmit a random access request message, the described techniques may avoid declaring a collision in the case of both communication paths falling within an RTT and/or may avoid excessive transmission of msg2 and/or msgX.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

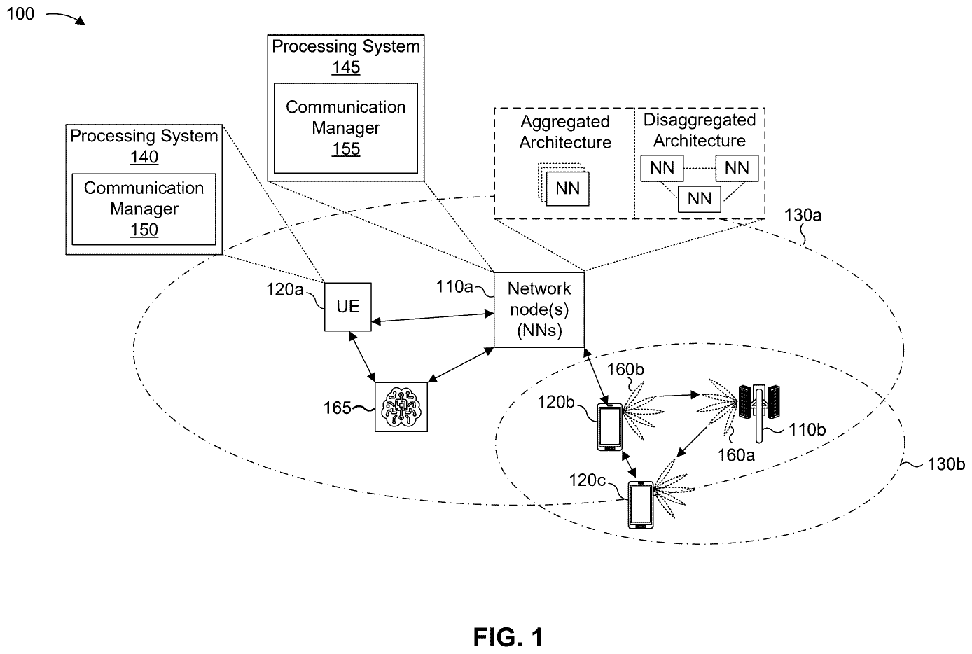

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHZ), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHZ, FR1 is often referred to (interchangeably) as a “sub-6 GHZ” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network node, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

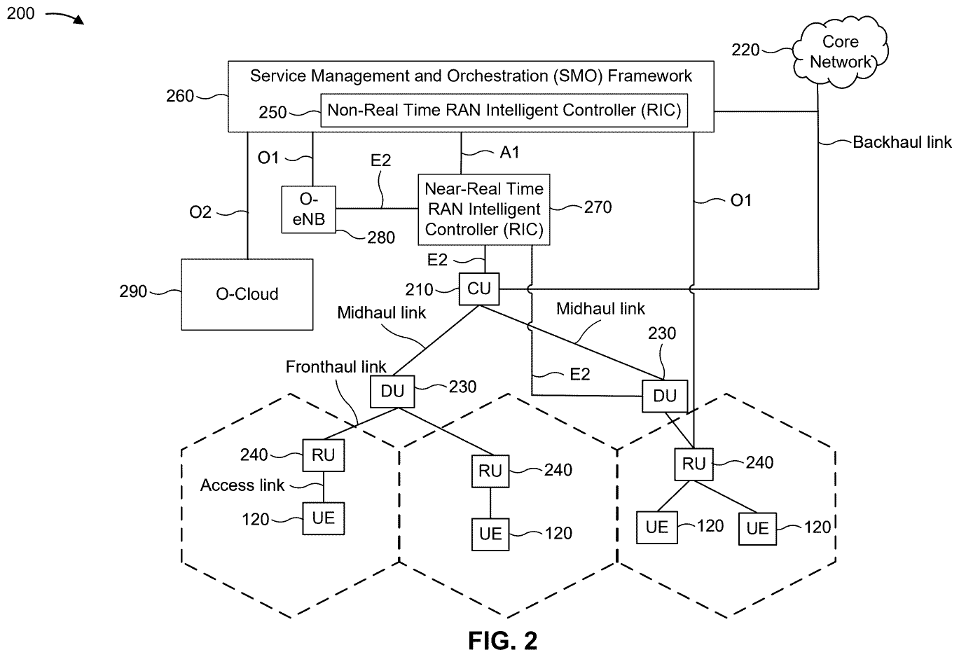

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, the network node 110 may include a communication manager 155. As described in more detail elsewhere herein, the communication manager 155 may receive, from a first UE 120, a first random access preamble including a first cyclic shift, and from a second UE 120, a second random access preamble including a second cyclic shift; transmit, to the first UE 120, a first random access response message including a first cyclic shift range in accordance with detecting a first communication path associated with the first cyclic shift and a second communication path associated with the second cyclic shift; receive a random access message from the first UE 120 in accordance with the first cyclic shift range; and transmit, to the second UE 120, a second random access response message including a second cyclic shift range in accordance with receiving the random access message from the first UE 120. Additionally, or alternatively, the communication manager 155 may perform one or more other operations described herein.

In some aspects, the UE 120 may include a communication manager 150. As described in more detail elsewhere herein, the communication manager 150 may transmit, to a network node 110, a random access preamble including a cyclic shift; receive, from the network node 110, a random access response message indicating a cyclic shift range associated with a communication path of the UE 120; and transmit a random access message in accordance with the cyclic shift range. Additionally, or alternatively, the communication manager 150 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

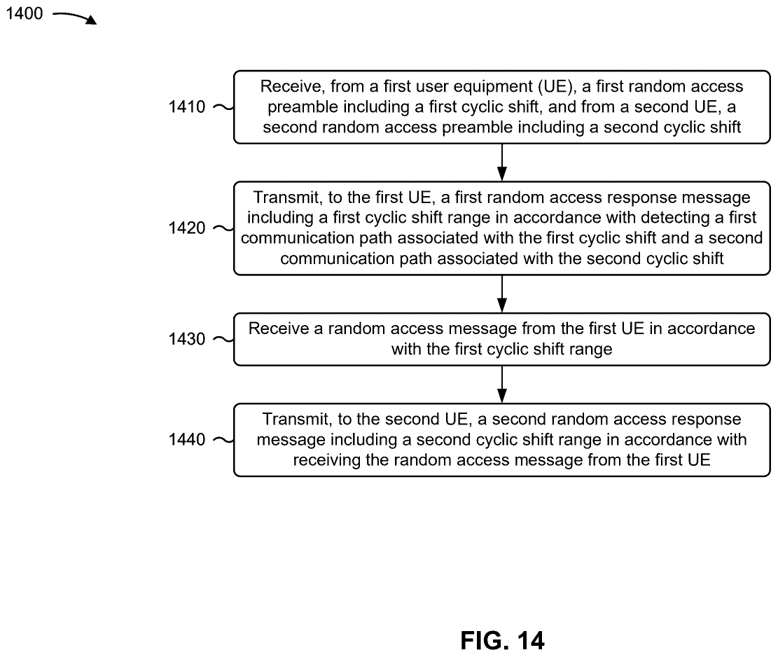

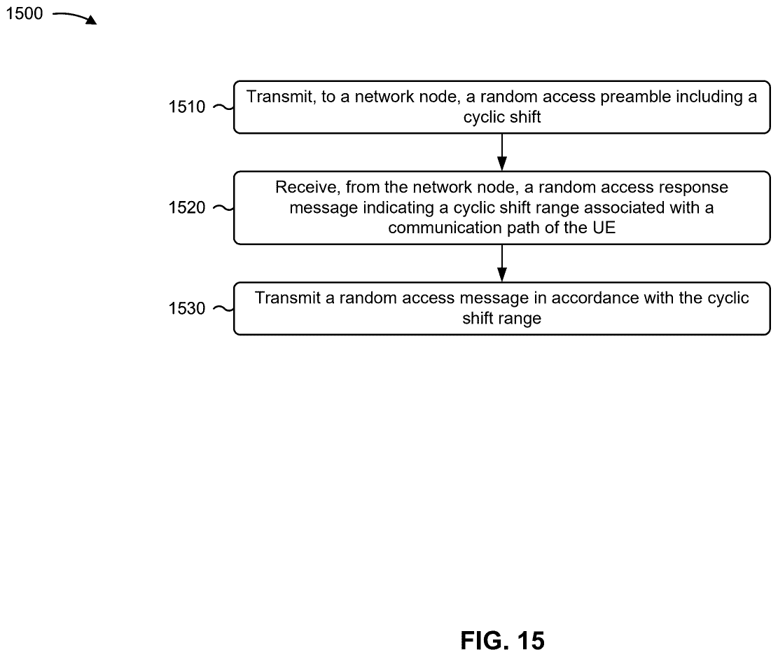

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with random access message transmission for PRACH using cyclic shift ranges, as described in more detail elsewhere herein. For example, the processing system 145 of the network node 110, the processing system 140 of the UE 120, the CU 210, the DU 230, or the RU 240 may perform or direct operations of, for example, process 1400 of FIG. 14, process 1500 of FIG. 15, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1400 of FIG. 14, process 1500 of FIG. 15, or other processes as described herein. In some examples, executing instructions may include running the instructions, converting the instructions, compiling the instructions, and/or interpreting the instructions, among other examples.

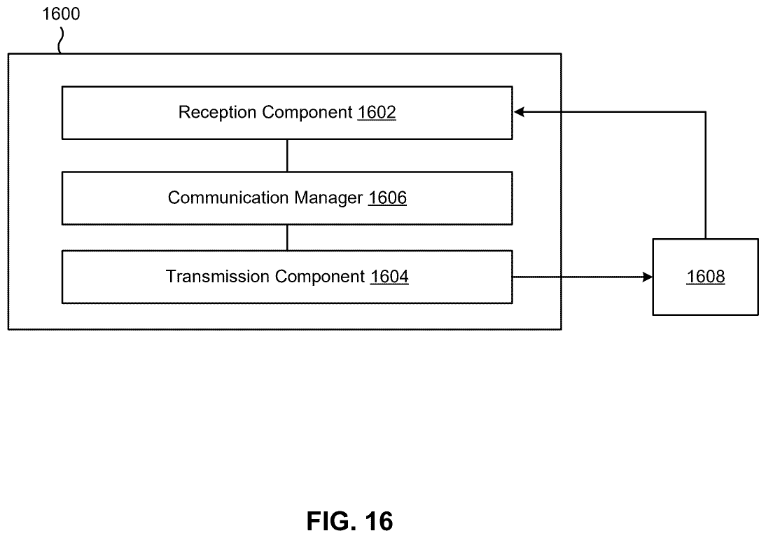

In some aspects, a network node includes means for receiving, from a first UE, a first random access preamble including a first cyclic shift, and from a second UE, a second random access preamble including a second cyclic shift; means for transmitting, to the first UE, a first random access response message including a first cyclic shift range in accordance with detecting a first communication path associated with the first cyclic shift and a second communication path associated with the second cyclic shift; means for receiving a random access message from the first UE in accordance with the first cyclic shift range; and/or means for transmitting, to the second UE, a second random access response message including a second cyclic shift range in accordance with receiving the random access message from the first UE. The means for the network node to perform operations described herein may include, for example, one or more of communication manager 155, processing system 145, a radio, one or more RF chains, one or more transceivers, one or more antennas, one or more modems, a reception component (for example, reception component 1602 depicted and described in connection with FIG. 16), and/or a transmission component (for example, transmission component 1604 depicted and described in connection with FIG. 16), among other examples.

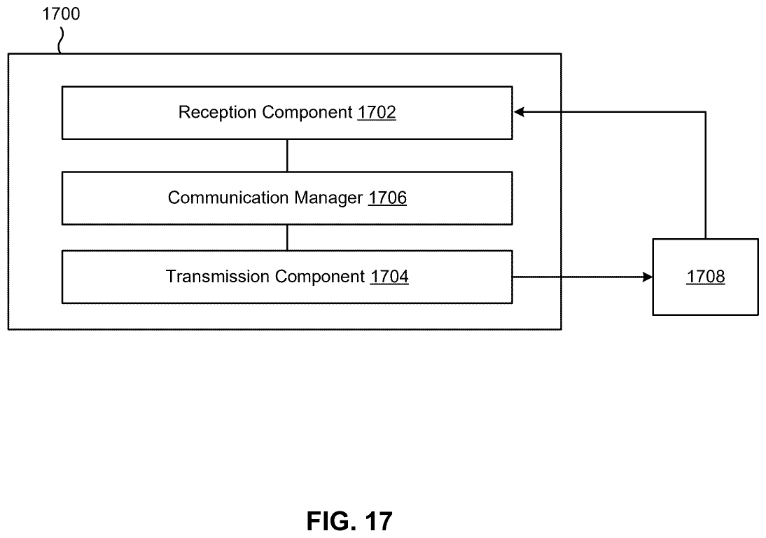

In some aspects, the UE 120 includes means for transmitting, to a network node 110, a random access preamble including a cyclic shift; means for receiving, from the network node, a random access response message indicating a cyclic shift range associated with a communication path of the UE 120; and/or means for transmitting a random access message in accordance with the cyclic shift range. The means for the UE 120 to perform operations described herein may include, for example, one or more of communication manager 150, processing system 140, a radio, one or more RF chains, one or more transceivers, one or more antennas, one or more modems, a reception component (for example, reception component 1702 depicted and described in connection with FIG. 17), and/or a transmission component (for example, transmission component 1704 depicted and described in connection with FIG. 17), among other examples.

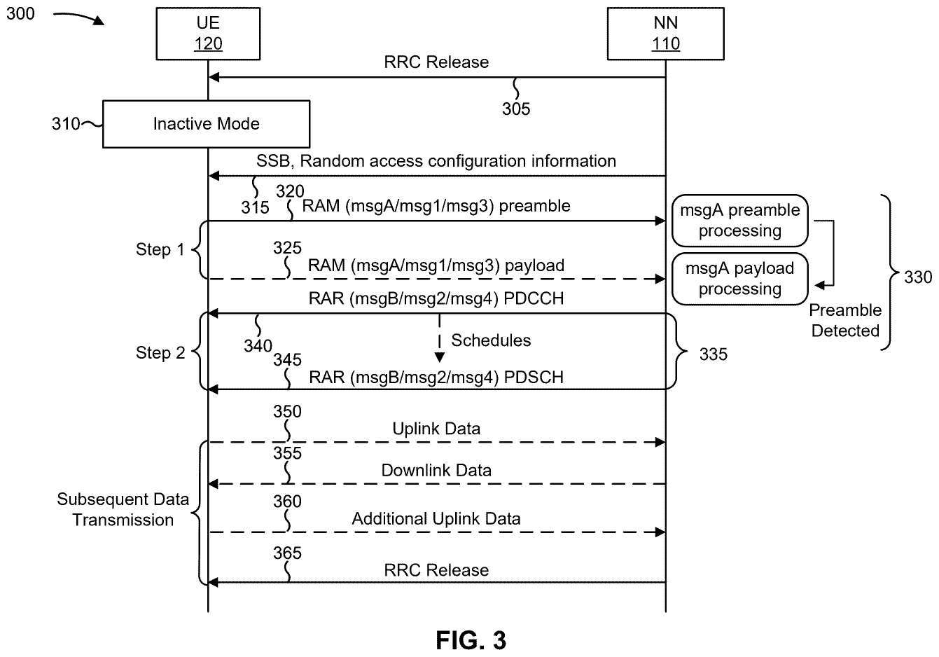

FIG. 3 is a diagram illustrating an example 300 including aspects of a two-step random access procedure and a four-step random access procedure that supports SDT, in accordance with the present disclosure. As shown in FIG. 3, a network node 110 and a UE 120 may communicate with one another to perform the two-step random access procedure and/or the four-step random access procedure. The UE 120 may support a connected communication mode (e.g., an RRC active mode), an idle communication mode (e.g., an RRC idle mode), and an inactive communication mode (e.g., an RRC inactive mode). The RRC inactive mode may functionally reside between the RRC active mode and the RRC idle mode.

The UE 120 may transition between different modes based at least in part on various commands and/or communications received from the network node 110. As shown by reference number 305, the network node 110 may transmit, and the UE 120 may receive, an RRC release message (e.g., RRCRelease). In some examples, the RRC release message may include a suspension message (e.g., SuspendConfig) that suspends a configuration of the UE 120. As shown by reference number 310, in association with receiving the RRC release message, the UE 120 may enter an inactive mode (e.g., RRC_INACTIVE mode). For example, the UE 120 may transition from RRC active mode to RRC inactive mode based at least in part on receiving an RRC release message including a suspension message (e.g., SuspendConfig).

When transitioning to RRC inactive mode, the UE 120 and/or the network node 110 may store a UE context (e.g., an access stratum (AS) context and/or higher-layer configurations). This permits the UE 120 and/or the network node 110 to apply the stored UE context when the UE 120 transitions from RRC inactive mode to RRC active mode in order to resume communications, which reduces latency of transitioning to RRC active mode relative to transitioning to the RRC active mode from RRC idle mode. While in the RRC inactive mode, the UE 120 may perform random-access-based SDT. For example, the UE 120 may perform a four-step random access procedure and/or a two-step random access procedure including the transmission of small data without transitioning into the RRC active mode.

As shown by reference number 315, the network node 110 may transmit, and the UE 120 may receive, one or more SSBs and/or random access configuration information. In some aspects, the random access configuration information may be transmitted in and/or indicated by system information (e.g., in one or more SIBs) and/or an SSB, such as for contention-based random access. Additionally, or alternatively, the random access configuration information may be transmitted in an RRC message and/or a PDCCH order message that triggers a RACH procedure, such as for contention-free random access. The random access configuration information may include one or more parameters to be used in the two-step random access procedure and/or the four-step random access procedure, such as one or more parameters for transmitting a random access message (RAM) and/or receiving an RAR to the RAM.

In some examples, the UE 120 may measure a reference signal received power (RSRP) of the one or more SSBs described in connection with reference number 315. In such examples, the UE 120 may initiate RA-SDT when it has a small data payload to communicate to the network node 110, and/or when a measured RSRP of the one or more SSBs satisfies an SDT-RSRP threshold.

As shown by reference number 320, in the example of a two-step random access procedure, the UE 120 may transmit, and the network node 110 may receive, a RAM preamble. As shown by reference number 325, in the example of a two-step random access procedure, the UE 120 may transmit, and the network node 110 may receive, a RAM payload. As shown, the UE 120 may transmit the RAM preamble and the RAM payload to the network node 110 as part of an initial (or first) step of the two-step random access procedure. In some aspects, the RAM may be referred to as message A, msgA, a first message, or an initial message in a two-step random access procedure. Furthermore, in some aspects, the RAM preamble may be referred to as a message A preamble, a msgA preamble, a preamble, or a PRACH preamble, and the RAM payload may be referred to as a message A payload, a msgA payload, or a payload. In some aspects, the RAM may include some or all of the contents of message 1 (msg1) and message 3 (msg3) of a four-step random access procedure, which is described in more detail below. For example, the RAM preamble may include some or all contents of message 1 (e.g., a PRACH preamble), and the RAM payload may include some or all contents of message 3 (e.g., a UE identifier, UCI, and/or a PUSCH) transmission.

As shown by reference number 320 and/or reference number 325, in the example of a four-step random access procedure, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

The preamble identifier may include or be an example of a preamble sequence, which may also be referred to herein as a PRACH sequence, a root sequence, or the like. To generate the preamble, the UE 120 may select a preamble sequence from a set of preamble sequences configured for random access procedures. The UE 120 may generate the preamble based on the selected preamble sequence and a selected cyclic shift from a set of cyclic shifts. The network node 110 may distinguish between preambles sent from multiple UEs according to the set of preamble sequences and the set of cyclic shifts, as each UE transmitting a preamble may select a different preamble sequence and/or cyclic shift. For example, the network node 110 may detect that received preambles originated from different UEs based on each preamble being associated with a different preamble sequence. Additionally, or alternatively, each preamble may have a different arrival time at the network node 110 according to the corresponding cyclic shift. Thus, even if two UEs select a same preamble sequence, the network node may detect that the received preambles originated from different UEs based on each preamble having a different arrival time at the network node. If multiple UEs select the same preamble, the network node may transmit a response message allocating resources for another random access message to each UE using the same preamble (e.g., a third message (msg3) of a four-step random access procedure), resulting in a collision due to multiple UEs transmitting via the same allocated resources.

As shown by reference number 320, in the example of a two-step random access procedure and/or reference number 325, in the example of a four-step random access procedure, the UE 120 may transmit an RRC connection request message. The RRC connection request message may be referred to as message 3, msg3, MSG3, or a third message of a four-step random access procedure. In some aspects, the RRC connection request (e.g., an RRC connection request, an RRC resume request) may include a UE identifier, UCI, and/or a PUSCH communication.

As shown by reference number 330, in the example of a two-step random access procedure, the network node 110 may receive the RAM preamble transmitted by the UE 120. If the network node 110 successfully receives and decodes the RAM preamble, the network node 110 may then receive and decode the RAM payload.

As shown by reference number 335, in the example of a two-step random access procedure, the network node 110 may transmit an RAR (sometimes referred to as an RAR message). As shown, the network node 110 may transmit the RAR message as part of a second step of the two-step random access procedure. In some aspects, the RAR message may be referred to as message B, msgB, or a second message in a two-step random access procedure. The RAR message may include some or all of the contents of message 2 (msg2) and message 4 (msg4) of the four-step random access procedure. For example, the RAR message may include the detected PRACH preamble identifier, the detected UE identifier, a timing advance value, and/or contention resolution information.

However, for RA-SDT, msgB and/or msg4 does not include an RRC signaling message. Additionally or alternatively, the network node 110 may otherwise transmit RRC signaling to transition the UE 120 to the RRC connected state.

As shown by reference number 340, in the example of a two-step random access procedure, as part of the second step of the two-step random access procedure, the network node 110 may transmit a PDCCH communication for the RAR. The PDCCH communication may schedule a PDSCH communication that includes the RAR. For example, the PDCCH communication may indicate a resource allocation (e.g., in DCI) for the PDSCH communication.

As shown by reference number 340 and/or reference number 345, in the example of a four-step random access procedure, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some aspects, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC protocol data unit (PDU) of the PDSCH communication.

As shown by reference number 345, in the example of a two-step random access procedure, as part of the second step of the two-step random access procedure, the network node 110 may transmit the PDSCH communication for the RAR, as scheduled by the PDCCH communication. The RAR may be included in a MAC PDU of the PDSCH communication. As shown by reference number 340, if the UE 120 successfully receives the RAR, the UE 120 may transmit a hybrid automatic repeat request (HARQ) ACK.

As shown by reference number 340 and/or 345, in the example of a four-step random access procedure, the network node 110 may transmit an RRC connection setup message. The RRC connection setup message may be referred to as message 4, msg4, MSG4, or a fourth message of a four-step random access procedure.

As shown by reference number 350, the UE 120 may perform SDT by transmitting a first uplink data message to the network node 110.

As shown by reference number 355, the network node 110 may transmit, and the UE 120 may receive, a downlink data message (e.g., in response to the uplink data described in connection with reference number 350).

As shown by reference number 360, the UE 120 may transmit, and the network node 110 may receive, additional uplink data. After MsgB/Msg4, SDT may be performed until an RRC message is received and/or a timer (e.g., t319-a timer) expires. For example, as shown by reference number 365, the network node 110 may transmit, and the UE 120 may receive, an RRC release message, which may end SDT between the UE 120 and the network node 110.

As indicated above, FIG. 3 is provided as an example. Other examples may differ from what is described with regard to FIG. 3.

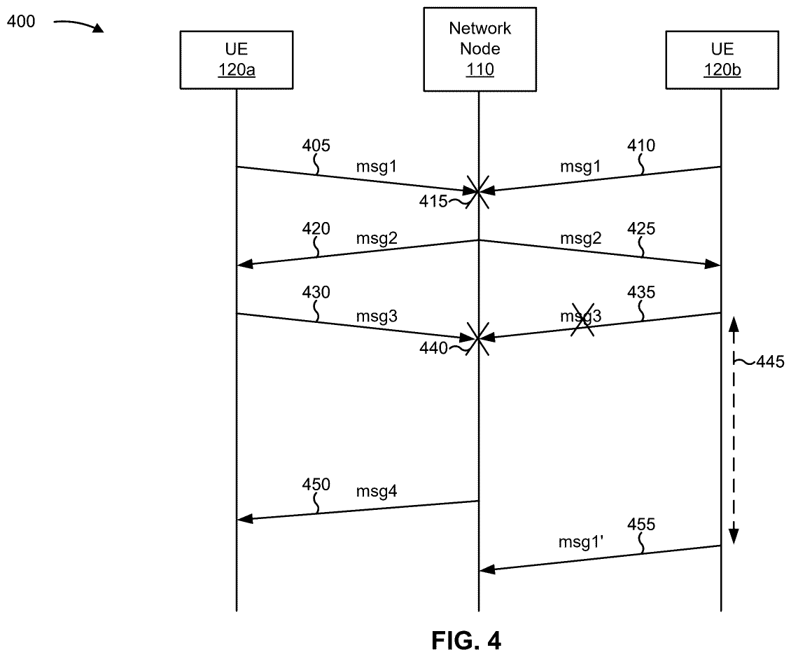

FIG. 4 is a diagram illustrating an example 400 of a random access message collision, in accordance with the present disclosure. Example 400 illustrates communications between a first UE 120a, a second UE 120b, and a network node 110, each of which may be examples of the corresponding devices described with reference to FIGS. 1-3. In some aspects, the first UE 120a, the second UE 120b, and the network node 110 may be included in a wireless network, such as wireless network 100. The first UE 120a, the second UE 120b, and the network node 110a may communicate via a wireless access link, which may include an uplink and a downlink.

According to some random access procedures, such as those similar to the four-step random access procedure described with respect to FIG. 3, the UE 120a and/or the UE 120b may randomly select a preamble (e.g., including a cyclic shift and/or a preamble root) for transmitting a first random access message (e.g., msg1). For example, as shown by reference number 405, the UE 120a may transmit a first msg1 including a random access preamble and, as shown by reference number 410, the UE 120b may transmit a second msg1 including a same random access preamble.

As shown by reference number 415, the network node may receive the first msg1 and the second msg1 and may detect a single UE. For example, the network node 110 may detect communication paths from multiple UEs and may transmit a msg2 for each detected preamble allocating resources for msg 3 transmission. However, in the example 400, the network node 110 may detect a single preamble and may allocate a same set of resources to the UE 120a and the UE 120b.

For example, as shown by reference number 420, the network node 110 may transmit, and the UE 120a may receive, a first msg2 including a resource allocation. As shown by reference number 425, the network node 110 may transmit, and the UE 120b may receive, a second msg2 including a same resource allocation in accordance with the network node 110 detecting the single preamble described in connection with reference number 415.

As shown by reference number 430, the UE 120a may transmit a first msg3 via the resource allocation. As shown by reference number 435, the UE 120b may transmit a second msg3 via the resource allocation. As shown by reference number 440, the network node 110 may detect a collision between the first msg3 and the second msg3 and/or may receive one of the first msg3 or the second msg3. As shown by reference number 450, the network node may transmit a msg4 to the UE corresponding to the detected msg 3 (e.g., UE 120a in the example 400).

A shown by reference number 445, based on the transmission of the second msg3, a contention resolution timer may be initiated. As shown by the reference number 455, the UE 120b may transmit a third msg1 (e.g., in a next random access interval) in response to the contention resolution timer expiring in the absence of a msg4 for the UE 120b. In some other examples, the UE 120b may transmit the third msg 1 in response to receiving a msg4 including a mismatched UE ID (e.g., a UE ID for a different UE than the UE 120b).

In some examples, however, if the network node 110 suspects that the msg1 transmission was received from more than one UE, the network node 110 may transmit an indication to the UE 120a and/or the UE 120b to transmit an additional msg1 using a new random hashing in a dedicated resource occasion, so that the retransmission of msg1 does not collide and the UE 120a and the UE 120b are distinguishable. However, retransmission of msg1 may incur avoidable delay and resource consumption.

As indicated above, FIG. 4 is provided as an example. Other examples may differ from what is described with respect to FIG. 4.

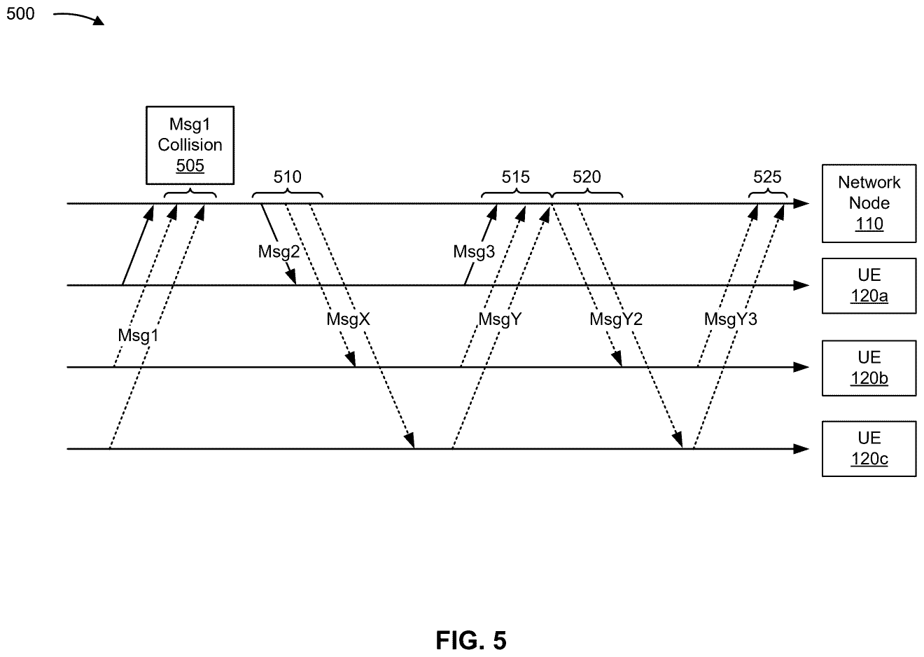

FIG. 5 is a diagram illustrating an example 500 of random access message collision resolution, in accordance with the present disclosure. Example 500 illustrates communications between a first UE 120a, a second UE 120b, a third UE 120c, and a network node 110, each of which may be examples of the corresponding devices described with reference to FIGS. 1-3. In some aspects, the first UE 120a, the second UE 120b, the third UE 120c, and the network node 110 may be included in a wireless network, such as wireless network 100. The first UE 120a, the second UE 120b, third UE 120c, and the network node 110a may communicate via a wireless access link, which may include an uplink and a downlink.

The first UE 120a, the second UE 120b, and the third UE 120c may each transmit a msg1 to the network node 110 as part of a random access procedure. As shown by reference number 505, the msg1 received from the UE 120c and the msg1 received from the UE 120b may result in a collision based on the UE 120b and UE 120c transmitting a same preamble. However, the network node 110 may detect the collision between the preambles of the UE 120b and the UE 120c based on a communication path associated with each of the UE 120b and the UE 120c. For example, due to a propagation delay associated with transmissions from the UE 120b and the UE 120c, the network node 110 may detect that the preamble is received from multiple UEs. For example, in relatively large cells, the UE 120b may be closer to the network node 110 than the UE 120c and thus, even though the UE 120b and the UE 120c selected the same preamble, the msg1 from the UE 120b will arrive at the network node 110 at a different time (e.g., a time of arrival that is distinguishable from the time of arrival of the msg1 from the UE 120b) than the msg1 from the UE 120c.

As a result, as shown by reference number 510, the network node 110 may transmit a msg2 to the UE 120a (e.g., the non-colliding UE) and may transmit a collision resolution message, such as msgX to each of the UE 120b and UE 120c. For example, if the network node 110 does not detect a collision between the communication paths (e.g., a collision between the communication path associated with the msg1 from the UE 120a and another communication path) based on the preamble, then the network node 110 may transmit a msg2 corresponding to that preamble, as described with reference to FIG. 3. If the network node 110 detects a collision, the network node 110 may be unable to assign the accurate timing to the UE 120b and/or the UE 120c, and instead may transmit the msgX allocating resources for msgY transmission.

As shown by reference number 515, the UE 120a may transmit a msg3 and each of the UE 120b and the UE 120c may transmit a contention resolution message, such as msgY. In some cases, the msgY may include one or more reference signals. Additionally, or alternatively, the UE 120b and/or UE 120c may retransmit the preamble to the network node 110 within the msgY and via a resource occasion indicated in the collision resolution message. In yet another example, the UE 120b and/or the UE 120c may select (e.g., reselect) a different preamble sequence, a different cyclic shift, or a combination thereof, to use for generating the msgY. The network node 110 may receive the msgY via the indicated resource occasion, which may avoid collisions with other preambles from other UEs 120. In some examples, the UE 120b and/or the UE 120 may randomly reselect a preamble and may transmit the msgY for collision resolution.

In response to the msgY, the network node 110 may transmit an RAR message (e.g., msgY2) to the UE 120 to continue the collision resolution for the random access procedure. For example, as shown by reference number 520, the network node 110 may transmit a second msgY to each of the UE 120b and the UE 120c as part of contention resolution. As shown by reference number 525, the UE 120b and the UE 120c may each transmit a third msgY to the network node 110 as part of contention resolution.

In some examples, the network node 110 may falsely detect a collision, such that a multipath signal from a single UE may be interpreted as being received from multiple UEs, which may lead to extra delay and/or extra overhead used by an extraneous collision resolution procedure.

As indicated above, FIG. 5 is provided as an example. Other examples may differ from what is described with respect to FIG. 5.

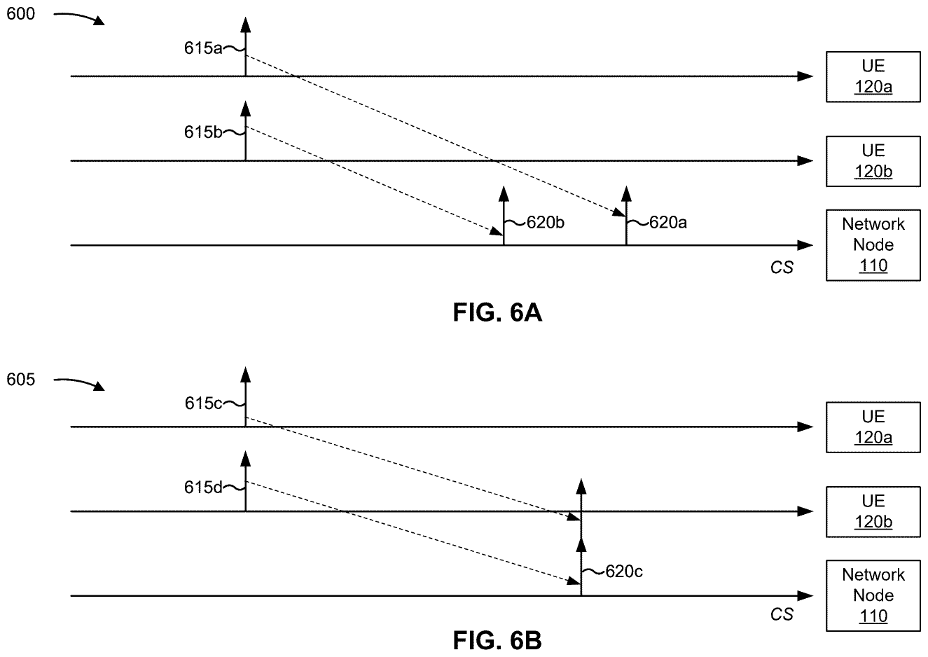

FIG. 6A is a diagram illustrating an example 600 of multipath detection, in accordance with the present disclosure. FIG. 6B is a diagram illustrating an example 605 of multipath collision, in accordance with the present disclosure. Examples 600 and 605 illustrate communications between a first UE 120a, a second UE 120b, and a network node 110, each of which may be examples of the corresponding devices described with reference to FIGS. 1-3. In some aspects, the first UE 120a, the second UE 120b, and the network node 110 may be included in a wireless network, such as wireless network 100. The first UE 120a, the second UE 120b, the third UE 120c, and the network node 110a may communicate via a wireless access link, which may include an uplink and a downlink.

In the example 600, the network node 110 may use multipath detection (e.g., in a cyclic shift domain) to detect a collision between random access preambles. Multipath detection may adequately detect collisions of random access preambles when a corresponding cell is relatively large, in part because the arrival times of random access preambles at the network node 110 transmitted by the UE 120a and the UE 120b located throughout the cell may differ (e.g., such that the random access preambles may be separable at the network node 110) due to the UE 120a and the UE 120b being geographically spaced out within the cell (e.g., due to differing distances between each of the UE 120a and the UE 120b, and the network node 110). For example, random access messages 615a and 615b may each include a same preamble, but random access message 615a may have an arrival time 620a and random access message 615b may have an arrival time 620b.

In the example 600, the network node 110 may assume that two or more random access preambles detected by the multipath detection and having the same cyclic shift originate from different UEs 120. In other cases, however, a single UE 120 may transmit a random access preamble via multipath signaling. The multipath detection of the network node 110 may flag such a multipath transmission as a collision (e.g., a false alarm). Such false alarms may lead to increased latency (e.g., delays), increased overhead (e.g., signaling overhead) for collision resolution, or both. The network node 110 may accordingly select parameters for the multipath detection to establish a balance between false alarms and detecting collisions. Additionally, or alternatively, the network node 110 may assume there is a collision with each random access preamble (e.g., even if a single path is detected) and may trigger collision resolution for every received random access preamble, which may result in increased latency and overhead.

In the example 605, the network node 110 may use multipath detection (e.g., in a cyclic shift domain) to detect a collision between random access preambles. However, in small cell scenarios, where there is not a significant separation between UE locations (e.g., and thus RTT), and/or hotspots (e.g., many UEs in a relatively small area) within a larger cell, the network node 110 may detect a single path if the UE 120a and UE 120b select the same preamble. For example, random access messages 615c and 615d may each include a same preamble, and may each have an arrival time 620c.

To improve the multipath detection in such example, the network node 110 may transmit a cyclic shift provisioning configuration to the UE 120b and the UE 120c in which the UEs may select from a larger quantity of cyclic shifts within a root, where the difference between cyclic shifts is smaller than a maximum RTT associated with the corresponding communication path. In such examples, the total quantity of roots in the example of extra-provisioned cyclic shifts may be the same as other cyclic shift configurations. However, a larger quantity of cyclic shifts may correspond to each root, and the UEs may select from the larger quantity of cyclic shifts to avoid preamble collision.

The UEs may be enabled to use each cyclic shift associated with a root, and thus, the likelihood of a communication path collision may be small, even in scenarios with a UE hotspot or small cell scenarios, because the transmitted cyclic shifts are randomly selected by each UE. However, because the difference between transmitted cyclic shifts may be smaller than the RTT, the network node 110 may encounter issues identifying timing for a particular UE and/or identifying collisions between UEs.

As indicated above, FIGS. 6A and 6B are provided as examples. Other examples may differ from what is described with respect to FIGS. 6A and 6B.

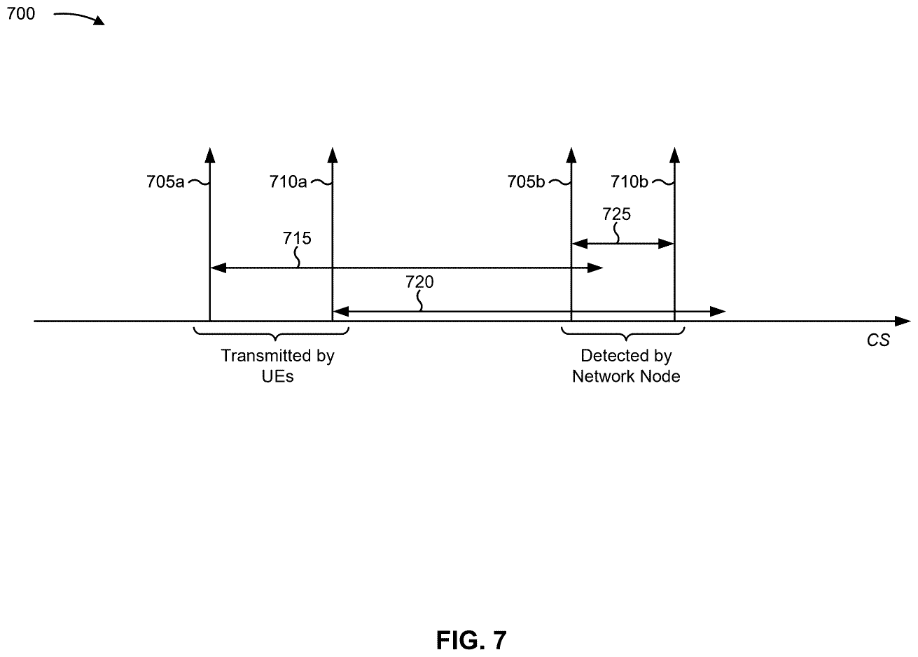

FIG. 7 is a diagram illustrating an example 700 of collision detection for extra-provisioned cyclic shifts, in accordance with the present disclosure. Example 700 illustrates a timeline for communications between a first UE (e.g., UE 120a as escribed herein), a second UE (e.g., a UE 120b as described herein), and a network node (e.g., a network node 110 as described herein).

In examples of extra-provisioned cyclic shifts, because the difference between transmitted cyclic shifts (e.g., transmitted communications paths 705a and 715a) is smaller than an RTT (e.g., RTT 720 and/or RTT 725), the network node may encounter issues ascertaining the timing for each UE and/or identifying collisions between multiple UE.

For the timing advance computation, the network node may transmit the absolute cyclic shift for the detected path, and a UE may compute the timing of a msg3 transmission by subtracting the transmitted cyclic shift (e.g., associated with communication path 705a and/or 710a) from a detected path cyclic shift (e.g., associated with communication path 705b and/or 710b). However, detecting the collision based on the detected paths being separated by less than the RTT may not be sufficient.

For example, there may be examples in which the detected paths at the network node (e.g., communication paths 705b and 710b) are within an RTT duration (e.g., RTT 715 and/or 720) (e.g., a maximum RTT duration). In such examples, some of the UEs may be able to identify accurate timing and/or the network node gNB may not be able to accurately estimate the collision and/or timing because each UE may have more information (e.g., the transmitted cyclic shift) than the network node, and thus may identify a detected path (e.g., detected communication path 705b and/or detected communication path 710b) with which it is associated.

In the example 700, the network node may detect two communications paths corresponding to UE 1 and UE 2, with a delay difference of less than the RTT, and thus the network node may not accurately ascertain which communication path is associated with which UE. For example, the network node may detect the communication path 705b from the first UE within the RTT 715 from the transmitted communication path 705a transmission. Thus, for the first UE, there is only one path (e.g., communication path 705b) detected within the RTT 715 from the first UE transmission, and the network node can accurately detect the timing for the first UE. The network node may detect the communication paths 705b and 710b within the RTT 720 from the UE random access message 710a transmission. Thus, for the second UE, there are two paths detected (e.g., communication path 705b and communication path 710b) within the RTT 720 duration from the second UE transmission. The network node may use information from a msgY to accurately detect the timing for the second UE for collision resolution and or collision avoidance.

As a result, the network node may detect a collision, but the first UE may not detect a collision (e.g., and thus the first UE may not perform any actions to resolve the collision without additional overhead and/or latency).

In some examples, the network node may transmit a msg2 if there is no collision detected by the network node, and/or may transmit a msgX if there is a collision detected by the network node. If the network node identifies a collision when the detected paths are separated by less than the RTT, there may be less wastage of msg3 resources; however, this may incur additional delay for UE that sees no collision (e.g., the first UE). For example, even though UE may be able to resolve the collision, the network node may transmit msgX, which may incur additional delay.

In some other examples, the network node may transmit both msg2 and msgX if there is a collision detected by the network node, and the UE may select either msg2 or msgX based on whether the UE detects a collision. As a result, there may be no additional delay for a UE that does not detect a collision; however, there may be a wastage of msg3 or msgX resources because the network node allocates both resources, and the UE may use one type of resources for transmitting the msg3 or the msgY.

Msg3 resources may be allocated on a per-UE basis (and thus may be wasted if the UE does not detect a collision). MsgX resources may be shared among multiple UEs (and thus one UE not using the resources does not necessitate that the resource is wasted). However, if the network node does not receive and/or identify information indicating how many UEs share the msgX resources, the network node may allocate a larger pool of msgX resources, which may waste more resources if some of the UEs are not using the msgX resources.

As indicated above, FIG. 7 is provided as an example. Other examples may differ from what is described with respect to FIG. 7.

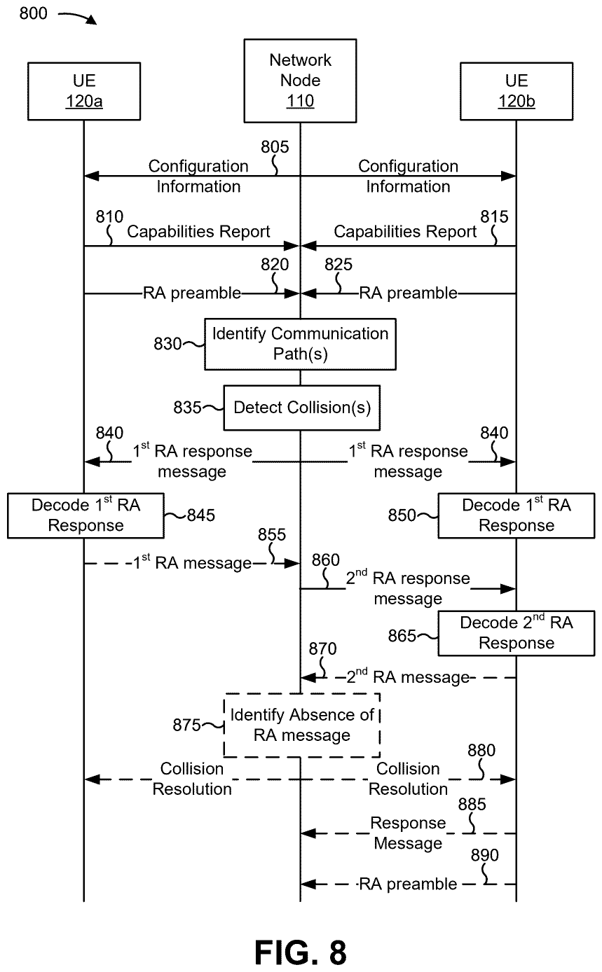

FIG. 8 is a diagram of an example 800 associated with random access message collision resolution using cyclic shift ranges, in accordance with the present disclosure. As shown in FIG. 8, a network node 110 (e.g., network node 110, a CU, a DU, and/or an RU) may communicate with a first UE 120a (e.g., UE 120) and/or a second UE 120b. In some aspects, the network node 110, the first UE 120a, and the second UE 120b may be part of a wireless network (e.g., wireless network 100). The UE 120a, the UE 120b, and the network node 110 may have established a wireless connection prior to operations shown in FIG. 8.

As shown by reference number 805, the network node 110 may transmit, and the first UE 120a and/or second UE 120b may receive, configuration information. In some aspects, the UE 120a and/or 120b may receive the configuration information via one or more of system information (e.g., a master information block (MIB) and/or a system information block (SIB), among other examples), RRC signaling, one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC CEs and/or one or more DCI messages, among other examples.

In some aspects, the configuration information may indicate that the first UE 120a and/or the second UE 120b is to perform cyclic range-based conflict resolution and/or path detection.

The first UE 120a and/or the second UE 120b may configure itself based at least in part on the configuration information. In some aspects, the first UE 120a and/or the second UE 120b may be configured to perform one or more operations described herein based at least in part on the configuration information.

As shown by reference number 810, the first UE 120a may transmit, and the network node may receive, a first capabilities report. Additionally or alternatively, as shown by reference number 815, the second UE 120b may transmit, and the network node 110 may receive, a second capabilities report. A capabilities report may indicate whether the corresponding UE supports a feature and/or one or more parameters related to the feature. For example, the capability information may indicate a capability and/or parameter for performing cyclic range-based conflict resolution and/or path detection. As another example, the capabilities report may indicate a capability and/or parameter for conflict resolution using random access conflict resolution messages. One or more operations described herein may be based on capability information of the capabilities report. For example, the UE may perform a communication in accordance with the capability information or may receive configuration information that is in accordance with the capability information. In some aspects, the capabilities report may indicate UE support for performing one or more timing advance calculations based on cyclic shift range information.

In some aspects, the configuration information described in connection with reference number 805 and/or the capabilities reports described in connection with reference numbers 810 and 815 may include information transmitted via multiple communications. Additionally, or alternatively, the network node 110 may transmit the configuration information, or a communication including at least a portion of the configuration information, before and/or after the UE 120a and/or the UE 120b transmits the capabilities report. For example, the network node 110 may transmit a first portion of the configuration information before the capabilities report, the first UE 120a and/or the second UE 120b may transmit at least a portion of the capabilities report, and the network node 11—may transmit a second portion of the configuration information after receiving the capabilities report.

As shown by reference number 820, the first UE 120a may transmit, and the network node 110 may receive, a random access preamble (e.g., a msg1 in a random access procedure as described in connection with FIG. 3). For example, the network node 110 may receive, from the first UE 120a, a first random access preamble including a first cyclic shift, and/or from the second UE 120b, a second random access preamble including a second cyclic shift. In some aspects, a preamble sequence in the first random access preamble and the second random access preamble is the same.

As shown by reference number 825, the second UE 120b may transmit, and the network node 110 may receive, a random access preamble (e.g., a msg1 in a random access procedure as described in connection with FIG. 3).

As shown by reference number 830, the network node 110 may identify one or more communication paths. For example, the network node 110 may identify a first communication path associated with the first UE 120a in association with receiving the first random access preamble described in connection with reference number 820. The first communication path may be associated with a first detected cyclic shift. In some aspects, the network node 110 may identify a second communication path associated with the second UE 120b in association with receiving the second random access preamble described in connection with reference number 825. In some aspects, an RTT associated with the first communication path at least partially overlaps in a cyclic shift domain with an RTT associated with the second communication path.

As shown by reference number 835, the network node 110 may detect one or more collision(s). For example, the network node 110 may detect a collision between the first communication path and the second communication path, in association with the RTT associated with the first communication path at least partially overlapping in the cyclic shift domain with the RTT associated with the second communication path. In some aspects, the network node 110 may detect a collision between the first communication path associated with the first cyclic shift and the second communication path associated with the second cyclic shift in accordance with receiving the first random access preamble described in connection with reference number 820 and the second random access preamble described in connection with reference number 825. In such aspects, the first cyclic shift may be within an RTT associated with the second cyclic shift.

As shown by reference number 840, the network node 110 may transmit, and the first UE 120a and/or the second UE 120b may receive, a first random access response message. For example, the network node 110 may transmit, to the first UE 120a and/or the second UE 120b, a first random access response message including a first cyclic shift range in accordance with detecting the first communication path associated with the first cyclic shift and the second communication path associated with the second cyclic shift (e.g., described in connection with reference number 830). In some aspects, transmitting the first random access response message and the second random access response message is associated with detecting the collision described in connection with reference number 835. In some aspects, the network node 110 may transmit the first random access response message to the first UE 120a and the second UE 120b sequentially (e.g., at different times) in association with detecting the collision (e.g., described in connection with reference number 835). In some other aspects, the network node 110 may transmit the first random access response message to the first UE 120a and the second UE 120b simultaneously (e.g., at a same time) in association with detecting the collision (e.g., described in connection with reference number 835).

In some aspects, the first cyclic shift range includes one or more cyclic shifts that are each associated with a single communication path within the RTT associated with the first communication path. In some aspects, the first random access response message may include and/or indicate one or more of the first cyclic shift range, an indication of the first cyclic shift (e.g., the first cyclic shift as detected by the network node 110), a resource allocation for communicating the random access message (e.g., a msg3 described in connection with reference number FIG. 3), and/or a transmit power command associated with the first cyclic shift.

As shown by reference number 845, the first UE 120a may decode the first random access response message. For example, the first UE 120a may decode the random access response message in accordance with an identifier associated with the random access response message. In such aspects, the first cyclic shift range includes the first cyclic shift and the first random access response message may indicate a resource allocation. The UE 120a may calculate a timing advance for transmitting the random access message via the resource allocation in association with the first cyclic shift range including the first cyclic shift. In such aspects, the random access message may include a connection request message (e.g., msg3).

As shown by reference number 850, the second UE 120b may decode the first random access response message. For example, the second UE 120b may decode the random access response message in accordance with an identifier associated with the random access response message. In such aspects, the first cyclic shift range may not include the second cyclic shift and the random access response message may indicate a resource allocation. As a result, the second UE 120b may refrain from transmitting a random access message via the resource allocation in response to the first random access response message described in connection with reference number 840 and/or may monitor for an additional random access response message.

As shown by reference number 855, in some aspects, the first UE 120a may transmit, and the network node 110 may receive, a first random access message (e.g., a first msg3 of a random access procedure as described in connection with FIG. 3). For example, the network node 110 may receive a random access message from the first UE 120a in accordance with the first cyclic shift range.

As shown by reference number 860, the network node 110 may transmit, and the second UE 120b may receive, a second random access response message. For example, the network node 110 may transmit, to the second UE 120b, a second random access response message including a second cyclic shift range in accordance with receiving the random access message from the first UE 120a (e.g., described in connection with reference number 855). In some aspects, the second cyclic shift range includes one or more cyclic shifts that are each associated with a single communication path within the RTT associated with the second communication path.

In some aspects, the network node 110 may transmit the first random access response message to the first UE 120a (e.g., described in connection with reference number 840) and may transmit the second random access response message to the second UE 120b sequentially in association with detecting the collision (e.g., described in connection with reference number 835).

As shown by reference number 865, the second UE 120b may decode the second random access response message.

As shown by reference number 870, in some aspects, the second UE 120b may transmit, and the network node 110 may receive, a second random access message (e.g., a second msg3 of a random access procedure as described in connection with FIG. 3). For example, the network node 110 may receive, from the second UE 120b, an additional random access message in accordance with the second cyclic shift range.

In some aspects, the network node 110 may transmit the first random access response message to the first UE and the second random access response message to the second UE simultaneously in association with detecting the collision described in connection with reference number 835.

In some aspects, the network node 110 may receive, from a third UE, a third random access preamble including a third cyclic shift associated with a third communication path. In such aspects, an RTT associated with the third communication path may be disjoint from an RTT associated with the first communication path and an RTT associated with the second communication path. As a result, the network node 110 may transmit, and the third UE may receive, a random access response message.

In some aspects, the network node 110 may receive from, a third UE, a third random access preamble including a third cyclic shift associated with a third communication path. In such aspects, an RTT associated with the third communication path may at least partially overlap with at least one of an RTT associated with the first communication path or an RTT associated with the second communication path. As a result, the network node 110 may transmit, to the third UE, a third random access message in accordance with receiving the random access message from the first UE 120a and receiving the additional random access message from the second UE 120b.

As shown by reference number 875, in some aspects, the network node 110 may identify an absence of a random access message. For example, the network node 110 may identify an absence of a random access message in a set of random access resources allocated via the first random access response message. Additionally or alternatively, the network node 110 may identify an absence of a random access message in a set of random access resources allocated via the second random access response message.

As shown by reference number 880, in some aspects, the network node 110 may transmit, and the first UE 120a and/or the second UE 120b may receive, a collision resolution message (e.g., msgX of a random access procedure described in connection with FIGS. 3-7). For example, the network node 110 may transmit, and the first UE 120a and/or the second UE 120b may receive, a collision resolution message. In some aspects, the network node 110 may transmit the collision resolution message to the first UE 120a and/or the second UE 120b in accordance with identifying the absence of a random access message from the first UE 120a and/or the second UE 120b (e.g., described in connection with reference number 875). In some aspects, the network node 110 may transmit the collision resolution message to the second UE 120b in accordance with receiving the random access message from the first UE 120a and/or identifying the absence of the additional random access message from the second UE 120b (e.g., described in connection with reference number 875). In some aspects, the collision resolution message may indicate a third cyclic shift range associated with a collision between the first communication path and the second communication path. For example, the collision resolution message may indicate a collided cyclic shift region (e.g., the range of cyclic shifts for which the first RTT overlaps with the second RTT).

As shown by reference number 885, in some aspects, the second UE 120b may transmit, and the network node 110 may receive, a collision resolution response message (e.g., msgY of a random access procedure described in connection with FIGS. 3-7). For example, the UE 120b may transmit, and the network node 110 may receive, according to the second cyclic shift and in association with receiving the collision resolution message (e.g., described in connection with reference number 880), a collision resolution response message in association with the third cyclic shift range including the second cyclic shift. In some aspects, the collision resolution message includes a resource allocation and the network node 110 may receive (e.g., the UE 120b may transmit) via the resource allocation and in association with transmitting the collision resolution message described in connection with reference number 880, a collision resolution response message in association with the third cyclic shift range.

As shown by reference number 890, in some aspects, the second UE 120b may transmit, and the network node 110 may receive, a random access preamble retransmission (e.g., msg1 retransmission of a random access procedure described in connection with FIG. 3). For example, the network node 110 may receive, and the UE 120b may transmit, a random access preamble retransmission including a third cyclic shift in association with the third cyclic shift range excluding the second cyclic shift. In some aspects, the third cyclic shift range includes a range of cyclic shifts in a cyclic shift domain that includes the first communication path and the second communication path.

As indicated above, FIG. 8 is provided as an example. Other examples may differ from what is described with respect to FIG. 8.

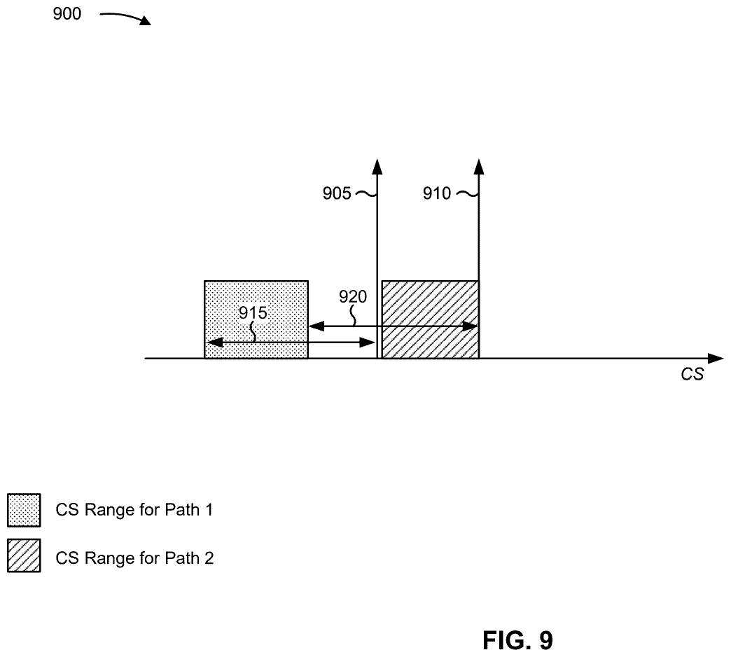

FIG. 9 is a diagram illustrating an example 900 associated with cyclic shift ranges, in accordance with the present disclosure. As shown in FIG. 9, example 900 includes communications between a first UE, a second UE, and a network node. In some aspects, the first UE, the second UE, and the network node may be included in a wireless network, such as wireless network 100. The first UE, the second UE, and the network node may communicate via a wireless access link, which may include an uplink and a downlink.

In the example 900, the network node may detect a first communication path 905 that is transmitted by the first UE (e.g., using a first cyclic shift). The first communication path may be associated with an RTT 915. The network node may additionally detect a second communication path 910 that is transmitted by the second UE (e.g., using a second cyclic shift). The second communication path may be associated with an RTT 920.

For each detected path, the network node may identify a range of transmitted cyclic shifts for which no collision happens (e.g., RTT 915 and RTT 920 do not overlap). In such aspects, the network node may transmit the range of cyclic shifts via a msg2 including a msg3 resource allocation. The range of transmitted cyclic shifts may include the set of cyclic shifts for which there is only one detected path within an RTT duration, for example, such that there is no ambiguity as to which transmitted cyclic shift is associated with which detected communication path. For example, the cyclic shift range for path 1 may include a range of transmitted cyclic shifts that does not include cyclic shifts that when used for transmission could have resulted in the second communication path 910 detected by the network node. The cyclic shift range for path 2 may include a range of transmitted cyclic shifts that does not include cyclic shifts that when used for transmission could have resulted in the first communication path 905 detected by the network node.

The first UE and/or the second UE may receive the msg2. The first UE and/or the second UE may each decode the msg2 to determine whether a transmitted cyclic shift is within the indicated cyclic shift range. For example, if a UE a determines that it transmitted the msg1 using a cyclic shift within the indicated range of cyclic shifts, then the UE may transmit a msg3 via the msg2 resource allocation. If a UE a determines that it transmitted the msg1 using a cyclic shift that is not within the indicated range of cyclic shifts, then the UE may refrain from transmitting a msg3 via the msg2 resource allocation.

In some aspects, the network node may detect multiple communications paths (e.g., communication path 905 and communication path 910) within an RTT (e.g., RTT 920). In such aspects, the network node may transmit one or more random access messages (e.g., msg2), each indicating a range of transmitted cyclic shifts. In some aspects, a network node may be configured and/or enabled to transmit the one or more random access messages sequentially, which may reduce latency associated with path detection.

As indicated above, FIG. 9 is provided as an example. Other examples may differ from what is described with respect to FIG. 9.

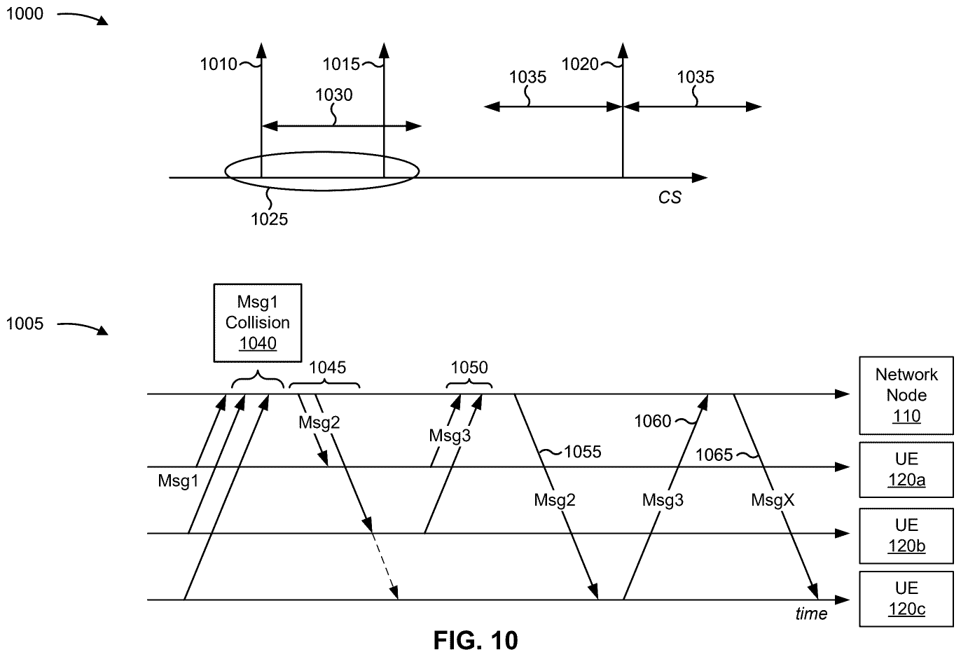

FIG. 10 is a diagram illustrating an example 1000 associated with a timeline for sequential random access message transmission, and an example 1005 associated with a sequential random access message transmission, in accordance with the present disclosure.

Examples 1000 and 1005 include communications between a first UE 120a, a second UE 120b, a third UE 120c, and a network node 110. In some aspects, the first UE 120a, the second UE 120b, the third UE 120c, and the network node 110 may be included in a wireless network, such as wireless network 100. The first UE 120a, the second UE 120b, the third UE 120c, and the network node 110 may communicate via a wireless access link, which may include an uplink and a downlink.

In some aspects, the network node 110 may be configured to transmit a random access response message (e.g., one or more msg2s) sequentially for a group of detected communication paths (e.g., communication paths 1010 and 1015) for which the network node 110 detected a collision (e.g., for which an RTT includes more than one communication path (e.g., RTT 1030)). For example, the network node 110 may detect a collision for a detected path when there are other detected paths within an RTT duration (e.g., communication paths 1010 and 1015). In such aspects, the network node 110 may divide the detected communication paths 1010, 1015, and 1020 into multiple groups.

For example, for each detected path in a first group 1025, there is at least one other detected path within an RTT duration. Other detected paths may be grouped into a second group based on being separated by at least an RTT duration from the communication paths in the group. For example, communication paths 1010 and 1015 may be in a first group 1025 based on the RTT 1030 overlapping with both communication paths, and the communication path 1020 may be in a second group based on the RTT 1035 being discrete from other RTTs and/or other communication paths.

For each group of detected communication paths, the network node 110 may transmit a msg2 corresponding to a first detected path (e.g., including a first cyclic shift range), and based on the msg3 response for that communication path, the network node 110 may proceed to transmitting a second msg2 for the next detected path (e.g., including a second cyclic shift range). The network node 110 may continue this procedure for each detected communication path in the first group 1025.

The network node 110 may determine an order of msg2 transmission for the detected communication paths based on the probability of a collision not occurring between the detected communication paths. For example, the network node 110 may calculate a probability of a collision not occurring for each communication path based on the corresponding cell characteristics. For example, the calculation may be based on whether there is a hotspot in the corresponding cell, and as a result, the arrival time distribution uniformity may be irregular (e.g., not uniformly distributed). The method that the network node 110 uses to calculate the probability of a collision not occurring may be associated with a configuration of the network node 110 and may be different than other methods used by other network nodes performing a similar calculation.

In the example 1005, the network node 110 may receive a msg1 from the UE 120a, the UE 120b, and/or the UE 120c. As shown by reference number 1040, the msg1 transmitted by the UE 120b and the msg1 transmitted by the UE 120c may result in a detected collision by the network node 110. As shown by reference number 1045, the network node 110 may transmit a first msg2 to the first UE 120a and may transmit a second msg2 to the second UE 120b and/or the third UE 120c.

As shown by reference number 1050, the network node 110 may receive a msg3 from the first UE 120a. The network node 110 may receive a msg3 from the second UE 120b based on the cyclic shift range in the msg2 including a cyclic shift used for transmission by the second UE 120b. As shown by reference number 1055, the network node 110 may transmit a msg2 to the third UE 120c based on receiving the msg3 from the first UE 120a and the second UE 120b. As shown by reference number 1060, the third UE 120c may transmit a msg3 to the network node 110. However, the network node 110 may identify an absence of the msg3 from the third UE 120c and as a result, as shown by reference number 1065 and based on receiving msg3 responses from each detected communication path, the network node 110 may, in some aspects, transmit a msgX to resolve any remaining collisions (e.g., may transmit a msgX to the third UE 120c).

For the detected communication paths that are not associated with a collision at the network node 110, the network node 110 may transmit a msg2 indicating msg3 resources (e.g., as shown by the msg2 transmitted to the first UE 120a described in connection with reference number 1045). For example, the network node 110 may not detect a collision for a detected path when there are no other detected communication paths within an RTT duration (e.g., detected communication path 1020) (e.g., a maximum RTT duration).

Eash msg2 may include a range of transmitted cyclic shifts, a detected cyclic shift corresponding to the detected communication path, a set of one or more resources for communicating a msg3, and/or a transmit power control command corresponding to the detected cyclic shift. In some aspects, the network node 110 may simultaneously transmit a msg2 associated with multiple detected communication paths within a group and/or between groups.

A UE 120 may decode the msg2 based on an RA-RNTI associated with the msg2. In some aspects, when the transmitted cyclic shift of a UE 120 matches and/or is included in the cyclic shift range indicated by the msg2 for a detected communication path (e.g., associated with a detected CS), then the UE 120 may calculate a timing advance by subtracting a transmitted cyclic shift from the detected cyclic shift (e.g., as indicated in the msg2). In such aspects, the UE 120 may transmit a msg3 using the allocated resources indicated by the msg2 (e.g., corresponding to the detected CS).

In some aspects, when the transmitted cyclic shift of a UE 120 does not match and/or is not included in the cyclic shift range indicated by the msg2 for a detected communication path (e.g., associated with a detected CS), then the UE 120 may monitor for a different or an additional msg2 (e.g., until the contention resolution timer described in connection with FIG. 4 expires).

A contention resolution message, such as msgX, may include a range of transmitted cyclic shifts, and/or a resource allocation for communicating a collision resolution response message (e.g., msgY). The range of transmitted cyclic shifts indicated by the msgX may include the set of cyclic shifts for which the network node 110 detected more than one communication path and a collision occurred. This range of cyclic shifts may be referred to as a collided cyclic shift region.

A UE 120 may decode the msgX based on the RA-RNTI associated with the msgX. In some aspects, the transmitted cyclic shift of a UE 120 matches and/or is included in the cyclic shift range indicated by the msgX. In such aspects, the UE 120 may transmit a msgY via the allocated resources indicated by the msgX. In some aspects, when the transmitted cyclic shift of a UE 120 does not match and/or is not included in the cyclic shift range indicated by the msgX, then the UE 120 may retransmit a random access preamble during a next random access resource occasion using a power ramp. In some aspects, the msg1 retransmission may include a same or different random access preamble sequence as the original preamble.

As indicated above, FIG. 10 is provided as an example. Other examples may differ from what is described with respect to FIG. 10.

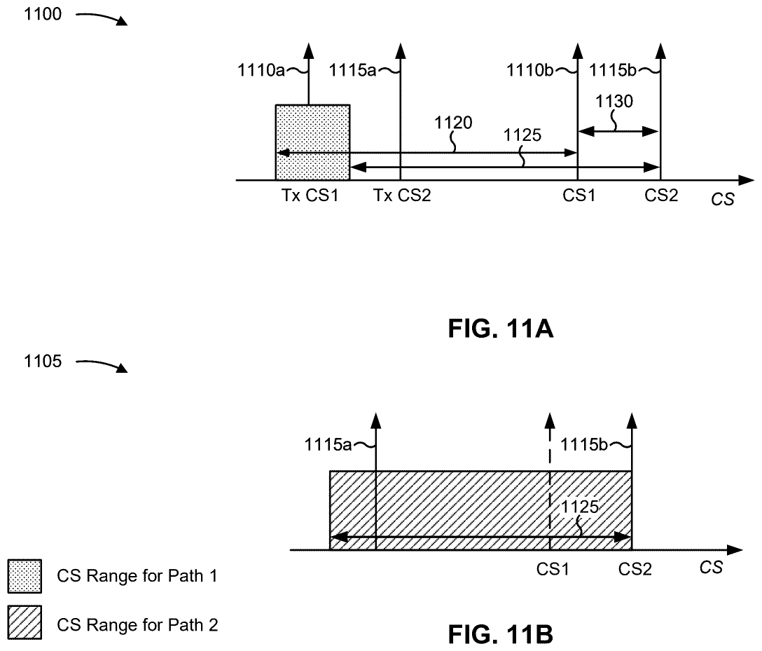

FIG. 11A is a diagram illustrating an example 1100 associated with random access message collision detection, in accordance with the present disclosure. FIG. 11B is a diagram illustrating an example 1105 associated with random access message collision resolution, in accordance with the present disclosure. Examples 1100 and 1105 include communications between a first UE, a second UE, and a network node. In some aspects, the first UE, the second UE, and the network node may be included in a wireless network, such as wireless network 100. The first UE, the second UE, and the network node may communicate via a wireless access link, which may include an uplink and a downlink.

In the example 1100, the network node may detect a first communication path 1110 that is transmitted by the first UE using a first cyclic shift. The first communication path may be associated with an RTT 1120 and may include a transmitted communication path 1110a and a detected communication path 1110b. The network node may additionally detect a second communication path 1115 that is transmitted by the second UE using a second cyclic shift. The second communication path may be associated with an RTT 1125 and may include a transmitted communication path 1115a and a detected communication path 1115b. According to the example 1100, the network node may detect a collision between the communication path 1110b and the communication path 1115b (e.g., because the communication path 1110b is within an RTT 1125 of the communication path 1115b). In the example 1100, a separation 1130 between the communication path 1110b and the communication path 1115b may be less than the RTT 1120 and/or the RTT 1125. The network node may group the detected communication path 1110b and the detected communication path 1115b based on detecting the collision. The network node may calculate one or more probabilities that a collision will not occur for each detected communication path 1110b and 1115b. In the example 1100, the network node may calculate that the detected path 1110b has a higher probability of not colliding.

The network node may transmit, to the first UE and the second UE, a msg2 indicating a cyclic shift range for the first communication path 1110b. In some aspects, the msg2 may include a resource allocation for a msg3 and/or may include a transmit power control command corresponding to CS1. The first UE and the second UE may each decode the msg2. The first UE may identify that Tx CS1 is within the cyclic shift range. As a result, the first UE may transmit a msg3 via the msg2 resource allocation. The second UE may identify that Tx CS2 is not within the cyclic shift range and thus may refrain from transmitting a msg3 via the msg2 resource allocation.

In the example 1105, the network node may receive the msg3 from the first UE and may thus identify that the communication path 1110b is from the first UE. The network node may transmit a second msg2 to the second UE indicating a cyclic shift range for the communication path 1115. In some aspects, the msg2 may include a resource allocation for a second msg3 and/or may include a transmit power control command corresponding to CS2. The second UE may identify that Tx CS2 is within the cyclic shift range. As a result, the second UE may transmit a msg3 via the second msg2 resource allocation.

As indicated above, FIGS. 11A and 11B are provided as examples. Other examples may differ from what is described with respect to FIGS. 11A and 11B.

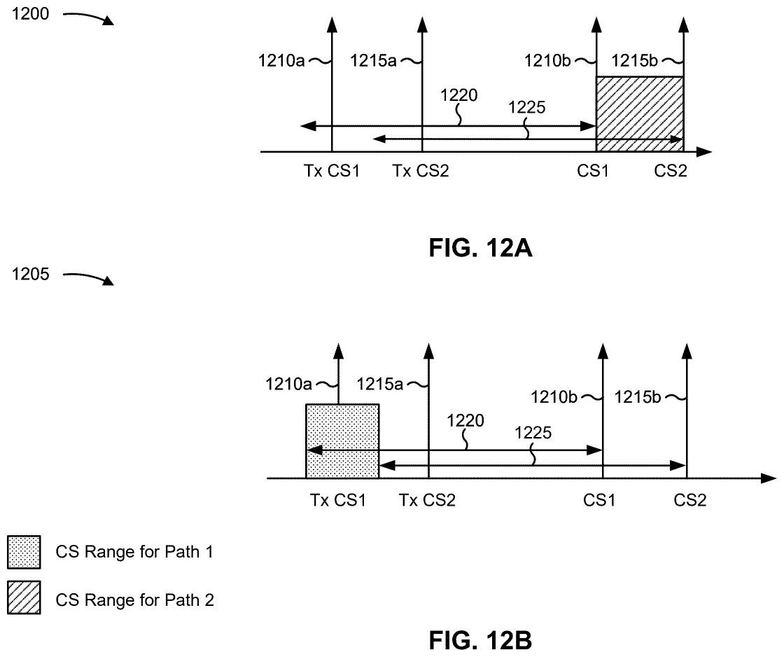

FIG. 12A is a diagram illustrating an example 1200 associated with random access message collision detection, in accordance with the present disclosure. FIG. 12B is a diagram illustrating an example 1205 associated with random access message collision resolution, in accordance with the present disclosure. Examples 1200 and 1205 include communications between a first UE, a second UE, and a network node. In some aspects, the first UE, the second UE, and the network node may be included in a wireless network, such as wireless network 100. The first UE, the second UE, and the network node may communicate via a wireless access link, which may include an uplink and a downlink.

In the example 1200, the network node may detect a first communication path 1210 that is transmitted by the first UE using a first cyclic shift. The first communication path may be associated with an RTT 1220 and may include a transmitted communication path 1210a and a detected communication path 1210b. The network node may additionally detect a second communication path 1215 that is transmitted by the second UE using a second cyclic shift. The second communication path may be associated with an RTT 1225 and may include a transmitted communication path 1215a and a detected communication path 1215b. According to the example 1200, the network node may detect a collision between the communication path 1210b and the communication path 1215b (e.g., because the communication path 1210b is within an RTT 1125 of the communication path 1215b). The network node may group the detected communication path 1210b and the detected communication path 1215b based on detecting the collision. The network node may calculate one or more probabilities that a collision will not occur for each detected communication path 1210b and 1215b. In the example 1200, the network node may calculate that the communication path 1215b has a higher probability of not colliding.

The network node may transmit, to the first UE and the second UE, a msg2 indicating a cyclic shift range for the second communication path 1215b. In some aspects, the msg2 may include a resource allocation for a msg3 and/or may include a transmit power control command corresponding to CS2. The first UE and the second UE may each decode the msg2. The first UE may identify that Tx CS1 is not within the cyclic shift range. As a result, the first UE may refrain from transmitting a msg3 via the msg2 resource allocation. The second UE may additionally identify that Tx CS2 is not within the cyclic shift range, and thus may also refrain from transmitting a msg3 via the msg2 resource allocation.

In the example 1205, the network node may determine an absence of a msg3 via the msg2 resource allocation. As a result, the network node may transmit, to the first UE and the second UE, a second msg2 indicating a second cyclic shift range that is for the first communication path 1210b. In some aspects, the second msg2 may include a second resource allocation for a msg3 and/or may include a transmit power control command corresponding to CS1.

The first UE may identify that Tx CS1 is within the second cyclic shift range. As a result, the first UE may transmit a msg3 via the second msg2 resource allocation. The second UE may identify that Tx CS2 is not within the cyclic shift range and thus may refrain from transmitting a msg3 via the second msg2 resource allocation.

The network node may receive the msg3 from the first UE and may thus identify that the communication path 1210b is from the first UE. The network node may transmit a third msg2 to the second UE indicating a third cyclic shift range (not depicted) for the communication path 1215. In some aspects, the third msg2 may include a third resource allocation for a second msg3 and/or may include a transmit power control command corresponding to CS2. The second UE may identify that Tx CS2 is within the third cyclic shift range. As a result, the second UE may transmit a msg3 via the third msg2 resource allocation.

As indicated above, FIGS. 12A and 12B are provided as examples. Other examples may differ from what is described with respect to FIGS. 12A and 12B.

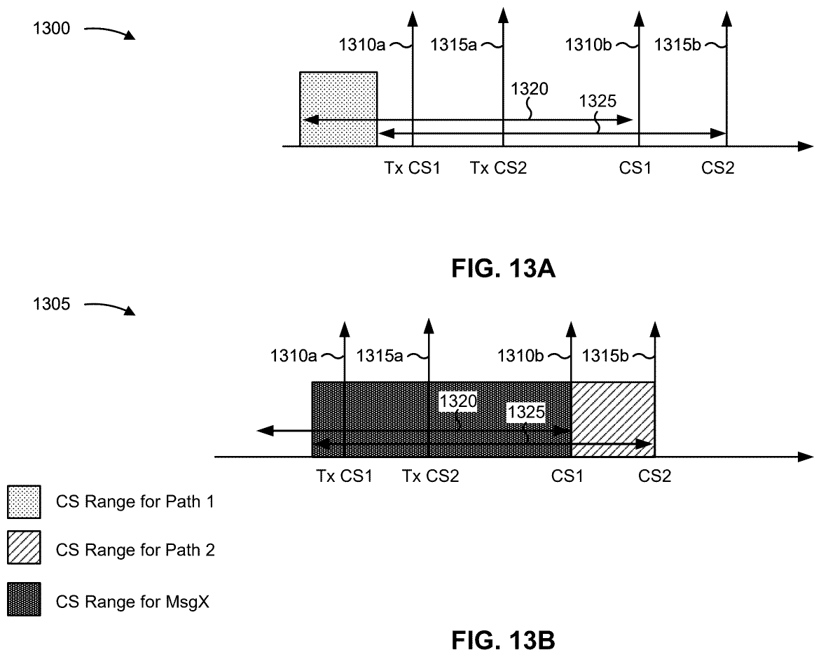

FIG. 13A is a diagram illustrating an example 1300 associated with random access message collision detection, in accordance with the present disclosure. FIG. 13B is a diagram illustrating an example 1305 associated with random access message collision resolution, in accordance with the present disclosure. Examples 1300 and 1305 include communications between a first UE, a second UE, and a network node. In some aspects, the first UE, the second UE, and the network node may be included in a wireless network, such as wireless network 100. The first UE, the second UE, and the network node may communicate via a wireless access link, which may include an uplink and a downlink.

In the example 1300, the network node may detect a first communication path 1110 that is transmitted by the first UE using a first cyclic shift. The first communication path may be associated with an RTT 1320 and may include a transmitted communication path 1310a and a detected communication path 1310b. The network node may additionally detect a second communication path 1315 that is transmitted by the second UE using a second cyclic shift. The second communication path may be associated with an RTT 1325 and may include a transmitted communication path 1315a and a detected communication path 1315b. According to the example 1300, the network node may detect a collision between the communication path 1310b and the communication path 1315b (e.g., because the communication path 1310b is within an RTT 1325 of the communication path 1315b). The network node may group the detected communication path 1310b and the detected communication path 1315b based on detecting the collision. The network node may calculate one or more probabilities that a collision will not occur for each detected communication path 1310b and 1315b. In the example 1300, the network node may calculate that the detected path 1310b has a higher probability of not colliding.

The network node may transmit, to the first UE and the second UE, a msg2 indicating a cyclic shift range for the first communication path 1310b. In some aspects, the msg2 may include a resource allocation for a msg3 and/or may include a transmit power control command corresponding to CS1. The first UE and the second UE may each decode the msg2. The first UE may identify that Tx CS1 is not within the cyclic shift range. As a result, the first UE may refrain from transmitting a msg3 via the msg2 resource allocation. The second UE may additionally identify that Tx CS2 is not within the cyclic shift range and thus may also refrain from transmitting a msg3 via the msg2 resource allocation.

In the example 1305, the network node may determine an absence of a msg3 via the msg2 resource allocation, which may indicate to the network node that a collision occurred for both the first UE and the second UE. Thus, the network node may transmit, to the first UE and/or the second UE, a msgX indicating a second cyclic shift range to resolve the conflict. The second cyclic shift range may include a collided cyclic shift region (e.g., the range of cyclic shifts for which the RTT 1320 overlaps with the RTT 1325). In some aspects, each msgX may include a resource allocation for a corresponding msgY.

As indicated above, FIGS. 13A and 13B are provided as examples. Other examples may differ from what is described with respect to FIGS. 13A and 13B.

FIG. 14 is a diagram illustrating an example process 1400 performed, for example, at a network node or an apparatus of a network node, in accordance with the present disclosure. Example process 1400 is an example where the apparatus or the network node (e.g., network node 110) performs operations associated with random access message collision resolution using cyclic shift ranges.

As shown in FIG. 14, in some aspects, process 1400 may include receiving, from a first UE, a first random access preamble including a first cyclic shift, and from a second UE, a second random access preamble including a second cyclic shift (block 1410). For example, the network node (e.g., using reception component 1602 and/or communication manager 1606, depicted in FIG. 16) may receive, from a first UE, a first random access preamble including a first cyclic shift, and from a second UE, a second random access preamble including a second cyclic shift, as described above.

As further shown in FIG. 14, in some aspects, process 1400 may include transmitting, to the first UE, a first random access response message including a first cyclic shift range in accordance with detecting a first communication path associated with the first cyclic shift and a second communication path associated with the second cyclic shift (block 1420). For example, the network node (e.g., using transmission component 1604 and/or communication manager 1606, depicted in FIG. 16) may transmit, to the first UE, a first random access response message including a first cyclic shift range in accordance with detecting a first communication path associated with the first cyclic shift and a second communication path associated with the second cyclic shift, as described above.

As further shown in FIG. 14, in some aspects, process 1400 may include receiving a random access message from the first UE in accordance with the first cyclic shift range (block 1430). For example, the network node (e.g., using reception component 1602 and/or communication manager 1606, depicted in FIG. 16) may receive a random access message from the first UE in accordance with the first cyclic shift range, as described above.

As further shown in FIG. 14, in some aspects, process 1400 may include transmitting, to the second UE, a second random access response message including a second cyclic shift range in accordance with receiving the random access message from the first UE (block 1440). For example, the network node (e.g., using transmission component 1604 and/or communication manager 1606, depicted in FIG. 16) may transmit, to the second UE, a second random access response message including a second cyclic shift range in accordance with receiving the random access message from the first UE, as described above.

Process 1400 may include additional aspects, such as any single aspect or any combination of aspects described below and/or in connection with one or more other processes described elsewhere herein.

In a first aspect, process 1400 includes identifying the first communication path associated with the first UE in association with receiving the first random access preamble, and identifying the second communication path associated with the second UE in association with receiving the second random access preamble, wherein a round trip time associated with the first communication path at least partially overlaps in a cyclic shift domain with a round trip time associated with the second communication path.

In a second aspect, alone or in combination with the first aspect, the first cyclic shift range includes one or more cyclic shifts that are each associated with a single communication path within a round trip time associated with the first communication path, and the second cyclic shift range includes one or more cyclic shifts that are each associated with a single communication path within a round trip time associated with the second communication path.

In a third aspect, alone or in combination with one or more of the first and second aspects, process 1400 includes detecting a collision between the first communication path and the second communication path in association with a round trip time associated with the first communication path at least partially overlapping in a cyclic shift domain with a round trip time associated with the second communication path, wherein transmitting the first random access response message and the second random access response message is associated with detecting the collision.

In a fourth aspect, alone or in combination with one or more of the first through third aspects, process 1400 includes detecting a collision between the first communication path associated with the first cyclic shift and the second communication path associated with the second cyclic shift in accordance with receiving the first random access preamble and the second random access preamble, wherein the first cyclic shift is within a round trip time associated with the second cyclic shift.

In a fifth aspect, alone or in combination with one or more of the first through fourth aspects, the first random access response message includes a resource allocation for communicating the random access message with the first UE.

In a sixth aspect, alone or in combination with one or more of the first through fifth aspects, the first random access response message includes one or more of the first cyclic shift range, an indication of the first cyclic shift, a resource allocation for communicating the random access message, or a transmit power command associated with the first cyclic shift.

In a seventh aspect, alone or in combination with one or more of the first through sixth aspects, process 1400 includes detecting a collision between the first communication path and the second communication path, and transmitting the first random access response message to the first UE and transmitting the second random access response message to the second UE sequentially in association with detecting the collision.

In an eighth aspect, alone or in combination with one or more of the first through seventh aspects, process 1400 includes receiving an additional random access message from the second UE in accordance with the second cyclic shift range.

In a ninth aspect, alone or in combination with one or more of the first through eighth aspects, process 1400 includes receiving, from a third UE, a third random access preamble including a third cyclic shift associated with a third communication path, wherein a round trip time associated with the third communication path is disjoint from a round trip time associated with the first communication path and a round trip time associated with the second communication path, and transmitting, to the third UE, a random access response message.

In a tenth aspect, alone or in combination with one or more of the first through ninth aspects, process 1400 includes receiving, from a third UE, a third random access preamble including a third cyclic shift associated with a third communication path, wherein a round trip time associated with the third communication path at least partially overlaps with at least one of a round trip time associated with the first communication path or a round trip time associated with the second communication path, and transmitting, to the third UE, a third random access message in accordance with receiving the random access message from the first UE and receiving the additional random access message from the second UE.

In an eleventh aspect, alone or in combination with one or more of the first through tenth aspects, process 1400 includes identifying an absence of an additional random access message in a set of random access resources allocated via the second random access response message, and transmitting, to the second UE, a collision resolution message in accordance with receiving the random access message from the first UE and identifying the absence of the additional random access message from the second UE, wherein the collision resolution message indicates a third cyclic shift range associated with a collision between the first communication path and the second communication path.

In a twelfth aspect, alone or in combination with one or more of the first through eleventh aspects, process 1400 includes receiving, according to the second cyclic shift and in association with transmitting the collision resolution message, a collision resolution response message in association with the third cyclic shift range including the second cyclic shift.

In a thirteenth aspect, alone or in combination with one or more of the first through twelfth aspects, process 1400 includes receiving a random access preamble retransmission including a third cyclic shift in association with the third cyclic shift range excluding the second cyclic shift.

In a fourteenth aspect, alone or in combination with one or more of the first through thirteenth aspects, the third cyclic shift range includes a range of cyclic shifts in a cyclic shift domain that includes the first communication path and the second communication path.

In a fifteenth aspect, alone or in combination with one or more of the first through fourteenth aspects, the collision resolution message includes a resource allocation, and process 1400 includes receiving, via the resource allocation and in association with transmitting the collision resolution message, a collision resolution response message in association with the third cyclic shift range.

In a sixteenth aspect, alone or in combination with one or more of the first through fifteenth aspects, process 1400 includes detecting a collision between the first communication path and the second communication path, and transmitting the first random access response message to the first UE and the second random access response message to the second UE simultaneously in association with detecting the collision.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, at a UE or an apparatus of a UE, in accordance with the present disclosure. Example process 1500 is an example where the apparatus or the UE (e.g., UE 120) performs operations associated with random access message collision resolution using cyclic shift ranges.

As shown in FIG. 15, in some aspects, process 1500 may include transmitting, to a network node, a random access preamble including a cyclic shift (block 1510). For example, the UE (e.g., using transmission component 1704 and/or communication manager 1706, depicted in FIG. 17) may transmit, to a network node, a random access preamble including a cyclic shift, as described above.

As further shown in FIG. 15, in some aspects, process 1500 may include receiving, from the network node, a random access response message indicating a cyclic shift range associated with a communication path of the UE (block 1520). For example, the UE (e.g., using reception component 1702 and/or communication manager 1706, depicted in FIG. 17) may receive, from the network node, a random access response message indicating a cyclic shift range associated with a communication path of the UE, as described above.

As further shown in FIG. 15, in some aspects, process 1500 may include transmitting a random access message in accordance with the cyclic shift range (block 1530). For example, the UE (e.g., using transmission component 1704 and/or communication manager 1706, depicted in FIG. 17) may transmit a random access message in accordance with the cyclic shift range, as described above.

Process 1500 may include additional aspects, such as any single aspect or any combination of aspects described below and/or in connection with one or more other processes described elsewhere herein.

In a first aspect, a round trip time associated with the communication path at least partially overlaps in a cyclic shift domain with a round trip time associated with a communication path of a second UE.

In a second aspect, alone or in combination with the first aspect, process 1500 includes the cyclic shift range includes one or more cyclic shifts that are each associated with a single communication path within a round trip time associated with the communication path.

In a third aspect, alone or in combination with one or more of the first and second aspects, receiving the random access response message is associated with a collision between the communication path and an additional communication path in accordance with a round trip time associated with the communication path at least partially overlapping in a cyclic shift domain with a round trip time associated with the additional communication path.

In a fourth aspect, alone or in combination with one or more of the first through third aspects, a collision between the communication path associated with the cyclic shift and an additional communication path associated with an additional cyclic shift is associated with a round trip time associated with the additional cyclic shift including the cyclic shift.

In a fifth aspect, alone or in combination with one or more of the first through fourth aspects, process 1500 includes decoding the random access response message in accordance with an identifier associated with the random access response message, wherein the cyclic shift range includes the cyclic shift and the random access response message indicates a resource allocation, and calculating a timing advance for transmitting the random access message via the resource allocation, wherein the random access message includes a connection request message.

In a sixth aspect, alone or in combination with one or more of the first through fifth aspects, process 1500 includes decoding the random access response message in accordance with an identifier associated with the random access response message, wherein the cyclic shift range excludes the cyclic shift, and monitoring for an additional random access response message.

In a seventh aspect, alone or in combination with one or more of the first through sixth aspects, the random access response message includes a resource allocation for communicating the random access message with the network node.

In an eighth aspect, alone or in combination with one or more of the first through seventh aspects, the random access response message includes one or more of the cyclic shift range, an indication of the cyclic shift, a resource allocation for communicating the random access message, or a transmit power command associated with the cyclic shift.

In a ninth aspect, alone or in combination with one or more of the first through eighth aspects, process 1500 includes receiving a collision resolution message indicating an additional cyclic shift range associated with a collision between the communication path and an additional communication path associated with a second UE.

In a tenth aspect, alone or in combination with one or more of the first through ninth aspects, process 1500 includes decoding the collision resolution message in accordance with an identifier associated with the collision resolution message, wherein the collision resolution message indicates a resource allocation, and transmitting a collision resolution response message via the resource allocation in accordance with the additional cyclic shift range including the cyclic shift.

In an eleventh aspect, alone or in combination with one or more of the first through tenth aspects, process 1500 includes decoding the random access response message in accordance with an identifier associated with the random access response message, wherein the additional cyclic shift range excludes the cyclic shift, and transmitting an additional random access preamble including an additional cyclic shift.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram of an example apparatus 1600 for wireless communication, in accordance with the present disclosure. The apparatus 1600 may be a network node, or a network node may include the apparatus 1600. In some aspects, the apparatus 1600 includes a reception component 1602, a transmission component 1604, and/or a communication manager 1606, which may be in communication with one another (for example, via one or more buses and/or one or more other components). In some aspects, the communication manager 1606 is the communication manager 155 described in connection with FIG. 1. As shown, the apparatus 1600 may communicate with another apparatus 1608, such as a UE or a network node (such as a CU, a DU, an RU, or a base station), using the reception component 1602 and the transmission component 1604. The communication manager 1606 may be included in, or implemented via, a processing system (for example, the processing system 145 described in connection with FIG. 1) of the network node.

In some aspects, the apparatus 1600 may be configured to perform one or more operations described herein in connection with FIGS. 8-13. Additionally, or alternatively, the apparatus 1600 may be configured to perform one or more processes described herein, such as process 14 of FIG. 14, or a combination thereof. In some aspects, the apparatus 1600 and/or one or more components shown in FIG. 16 may include one or more components of the network node described in connection with FIG. 1. Additionally, or alternatively, one or more components shown in FIG. 16 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications, and may provide the processed signals to the one or more other components of the apparatus 1600. In some aspects, the reception component 1602 may include one or more components of the network node described above in connection with FIG. 1, such as a radio, one or more RF chains, one or more transceivers, or one or more modems, each of which may in turn be coupled with one or more antennas of the network node. In some aspects, the reception component 1602 and/or the transmission component 1604 may include or may be included in a network interface. The network interface may be configured to obtain and/or output signals for the apparatus 1600 via one or more communications links, such as a backhaul link, a midhaul link, and/or a fronthaul link.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications, and may transmit the processed signals to the apparatus 1608. In some aspects, the transmission component 1604 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1604 may be co-located with the reception component 1602.

The communication manager 1606 may support operations of the reception component 1602 and/or the transmission component 1604. For example, the communication manager 1606 may receive information associated with configuring reception of communications by the reception component 1602 and/or transmission of communications by the transmission component 1604. Additionally, or alternatively, the communication manager 1606 may generate and/or provide control information to the reception component 1602 and/or the transmission component 1604 to control reception and/or transmission of communications.

The reception component 1602 may receive, from a first UE, a first random access preamble including a first cyclic shift, and from a second UE, a second random access preamble including a second cyclic shift. The transmission component 1604 may transmit, to the first UE, a first random access response message including a first cyclic shift range in accordance with detecting a first communication path associated with the first cyclic shift and a second communication path associated with the second cyclic shift. The reception component 1602 may receive a random access message from the first UE in accordance with the first cyclic shift range. The transmission component 1604 may transmit, to the second UE, a second random access response message including a second cyclic shift range in accordance with receiving the random access message from the first UE.

The communication manager 1606 may identify the first communication path associated with the first UE in association with receiving the first random access preamble.

The communication manager 1606 may identify the second communication path associated with the second UE in association with receiving the second random access preamble, wherein a round trip time associated with the first communication path at least partially overlaps in a cyclic shift domain with a round trip time associated with the second communication path.

The communication manager 1606 may detect a collision between the first communication path and the second communication path in association with a round trip time associated with the first communication path at least partially overlapping in a cyclic shift domain with a round trip time associated with the second communication path, wherein transmitting the first random access response message and the second random access response message is associated with detecting the collision.

The communication manager 1606 may detect a collision between the first communication path associated with the first cyclic shift and the second communication path associated with the second cyclic shift in accordance with receiving the first random access preamble and the second random access preamble, wherein the first cyclic shift is within a round trip time associated with the second cyclic shift.

The communication manager 1606 may detect a collision between the first communication path and the second communication path.

The transmission component 1604 may transmit the first random access response message to the first UE and transmitting the second random access response message to the second UE sequentially in association with detecting the collision.

The reception component 1602 may receive an additional random access message from the second UE in accordance with the second cyclic shift range.

The reception component 1602 may receive, from a third UE, a third random access preamble including a third cyclic shift associated with a third communication path, wherein a round trip time associated with the third communication path is disjoint from a round trip time associated with the first communication path and a round trip time associated with the second communication path.

The transmission component 1604 may transmit, to the third UE, a random access response message.

The reception component 1602 may receive, from a third UE, a third random access preamble including a third cyclic shift associated with a third communication path, wherein a round trip time associated with the third communication path at least partially overlaps with at least one of a round trip time associated with the first communication path or a round trip time associated with the second communication path.

The transmission component 1604 may transmit, to the third UE, a third random access message in accordance with receiving the random access message from the first UE and receiving the additional random access message from the second UE.

The communication manager 1606 may identify an absence of an additional random access message in a set of random access resources allocated via the second random access response message.

The transmission component 1604 may transmit, to the second UE, a collision resolution message in accordance with receiving the random access message from the first UE and identifying the absence of the additional random access message from the second UE, wherein the collision resolution message indicates a third cyclic shift range associated with a collision between the first communication path and the second communication path.

The reception component 1602 may receive, according to the second cyclic shift and in association with transmitting the collision resolution message, a collision resolution response message in association with the third cyclic shift range including the second cyclic shift.

The reception component 1602 may receive, a random access preamble retransmission including a third cyclic shift in association with the third cyclic shift range excluding the second cyclic shift.

The communication manager 1606 may detect a collision between the first communication path and the second communication path.

The transmission component 1604 may transmit the first random access response message to the first UE and the second random access response message to the second UE simultaneously in association with detecting the collision.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

FIG. 17 is a diagram of an example apparatus 1700 for wireless communication, in accordance with the present disclosure. The apparatus 1700 may be a UE, or a UE may include the apparatus 1700. In some aspects, the apparatus 1700 includes a reception component 1702, a transmission component 1704, and/or a communication manager 1706, which may be in communication with one another (for example, via one or more buses and/or one or more other components). In some aspects, the communication manager 1706 is the communication manager 150 described in connection with FIG. 1. As shown, the apparatus 1700 may communicate with another apparatus 1708, such as a UE or a network node (such as a CU, a DU, an RU, or a base station), using the reception component 1702 and the transmission component 1704. The communication manager 1706 may be included in, or implemented via, a processing system (for example, the processing system 140 described in connection with FIG. 1) of the UE.

In some aspects, the apparatus 1700 may be configured to perform one or more operations described herein in connection with FIGS. 8-13. Additionally, or alternatively, the apparatus 1700 may be configured to perform one or more processes described herein, such as process 1500 of FIG. 15, or a combination thereof. In some aspects, the apparatus 1700 and/or one or more components shown in FIG. 17 may include one or more components of the UE described in connection with FIG. 1. Additionally, or alternatively, one or more components shown in FIG. 17 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1702 may receive communications, such as reference signals, control information, data communications, or a combination thereof, from the apparatus 1708. The reception component 1702 may provide received communications to one or more other components of the apparatus 1700. In some aspects, the reception component 1702 may perform signal processing on the received communications, and may provide the processed signals to the one or more other components of the apparatus 1700. In some aspects, the reception component 1702 may include one or more components of the UE described above in connection with FIG. 1, such as a radio, one or more RF chains, one or more transceivers, or one or more modems, each of which may in turn be coupled with one or more antennas of the UE.

The transmission component 1704 may transmit communications, such as reference signals, control information, data communications, or a combination thereof, to the apparatus 1708. In some aspects, one or more other components of the apparatus 1700 may generate communications and may provide the generated communications to the transmission component 1704 for transmission to the apparatus 1708. In some aspects, the transmission component 1704 may perform signal processing on the generated communications, and may transmit the processed signals to the apparatus 1708. In some aspects, the transmission component 1704 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1704 may be co-located with the reception component 1702.

The communication manager 1706 may support operations of the reception component 1702 and/or the transmission component 1704. For example, the communication manager 1706 may receive information associated with configuring reception of communications by the reception component 1702 and/or transmission of communications by the transmission component 1704. Additionally, or alternatively, the communication manager 1706 may generate and/or provide control information to the reception component 1702 and/or the transmission component 1704 to control reception and/or transmission of communications.

The transmission component 1704 may transmit, to a network node, a random access preamble including a cyclic shift. The reception component 1702 may receive, from the network node, a random access response message indicating a cyclic shift range associated with a communication path of the UE. The transmission component 1704 may transmit a random access message in accordance with the cyclic shift range.

The communication manager 1706 may decode the random access response message in accordance with an identifier associated with the random access response message, wherein the cyclic shift range includes the cyclic shift and the random access response message indicates a resource allocation.

The communication manager 1706 may calculate a timing advance for transmitting the random access message via the resource allocation, wherein the random access message includes a connection request message.

The communication manager 1706 may decode the random access response message in accordance with an identifier associated with the random access response message, wherein the cyclic shift range excludes the cyclic shift.

The communication manager 1706 may monitor for an additional random access response message.

The reception component 1702 may receive a collision resolution message indicating an additional cyclic shift range associated with a collision between the communication path and an additional communication path associated with a second UE.

The communication manager 1706 may decode the collision resolution message in accordance with an identifier associated with the collision resolution message, wherein the collision resolution message indicates a resource allocation.

The transmission component 1704 may transmit a collision resolution response message via the resource allocation in accordance with the additional cyclic shift range including the cyclic shift.

The communication manager 1706 may decode the random access response message in accordance with an identifier associated with the random access response message, wherein the additional cyclic shift range excludes the cyclic shift.

The transmission component 1704 may transmit an additional random access preamble including an additional cyclic shift.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

The following provides an overview of some Aspects of the present disclosure:

Aspect 1: A method of wireless communication performed by a network node, comprising: receiving, from a first user equipment (UE), a first random access preamble including a first cyclic shift, and from a second UE, a second random access preamble including a second cyclic shift; transmitting, to the first UE, a first random access response message including a first cyclic shift range in accordance with detecting a first communication path associated with the first cyclic shift and a second communication path associated with the second cyclic shift; receiving a random access message from the first UE in accordance with the first cyclic shift range; and transmitting, to the second UE, a second random access response message including a second cyclic shift range in accordance with receiving the random access message from the first UE.

Aspect 2: The method of Aspect 1, further comprising: identifying the first communication path associated with the first UE in association with receiving the first random access preamble; and identifying the second communication path associated with the second UE in association with receiving the second random access preamble, wherein a round trip time associated with the first communication path at least partially overlaps in a cyclic shift domain with a round trip time associated with the second communication path.

Aspect 3: The method of any of Aspects 1-2, wherein: the first cyclic shift range includes one or more cyclic shifts that are each associated with a single communication path within a round trip time associated with the first communication path; and the second cyclic shift range includes one or more cyclic shifts that are each associated with a single communication path within a round trip time associated with the second communication path.

Aspect 4: The method of any of Aspects 1-3, further comprising: detecting a collision between the first communication path and the second communication path in association with a round trip time associated with the first communication path at least partially overlapping in a cyclic shift domain with a round trip time associated with the second communication path, wherein transmitting the first random access response message and the second random access response message is associated with detecting the collision.

Aspect 5: The method of any of Aspects 1-4, further comprising: detecting a collision between the first communication path associated with the first cyclic shift and the second communication path associated with the second cyclic shift in accordance with receiving the first random access preamble and the second random access preamble, wherein the first cyclic shift is within a round trip time associated with the second cyclic shift.

Aspect 6: The method of any of Aspects 1-5, wherein the first random access response message includes a resource allocation for communicating the random access message with the first UE.

Aspect 7: The method of any of Aspects 1-6, wherein the first random access response message includes one or more of: the first cyclic shift range, an indication of the first cyclic shift, a resource allocation for communicating the random access message, or a transmit power command associated with the first cyclic shift.

Aspect 8: The method of any of Aspects 1-7, further comprising: detecting a collision between the first communication path and the second communication path; and transmitting the first random access response message to the first UE and transmitting the second random access response message to the second UE sequentially in association with detecting the collision.

Aspect 9: The method of any of Aspects 1-8, further comprising: receiving an additional random access message from the second UE in accordance with the second cyclic shift range.

Aspect 10: The method of Aspect 9, further comprising: receiving, from a third UE, a third random access preamble including a third cyclic shift associated with a third communication path, wherein a round trip time associated with the third communication path is disjoint from a round trip time associated with the first communication path and a round trip time associated with the second communication path; and transmitting, to the third UE, a random access response message.

Aspect 11: The method of Aspect 9, further comprising: receiving, from a third UE, a third random access preamble including a third cyclic shift associated with a third communication path, wherein a round trip time associated with the third communication path at least partially overlaps with at least one of a round trip time associated with the first communication path or a round trip time associated with the second communication path; and transmitting, to the third UE, a third random access message in accordance with receiving the random access message from the first UE and receiving the additional random access message from the second UE.

Aspect 12: The method of any of Aspects 1-11, further comprising: identifying an absence of an additional random access message in a set of random access resources allocated via the second random access response message; and transmitting, to the second UE, a collision resolution message in accordance with receiving the random access message from the first UE and identifying the absence of the additional random access message from the second UE, wherein the collision resolution message indicates a third cyclic shift range associated with a collision between the first communication path and the second communication path.

Aspect 13: The method of Aspect 12, further comprising: receiving, according to the second cyclic shift and in association with transmitting the collision resolution message, a collision resolution response message in association with the third cyclic shift range including the second cyclic shift.

Aspect 14: The method of Aspect 12, further comprising: receiving, a random access preamble retransmission including a third cyclic shift in association with the third cyclic shift range excluding the second cyclic shift.

Aspect 15: The method of Aspect 12, wherein the third cyclic shift range includes a range of cyclic shifts in a cyclic shift domain that includes the first communication path and the second communication path.

Aspect 16: The method of Aspect 12, wherein the collision resolution message includes a resource allocation, the method further comprising: receiving, via the resource allocation and in association with transmitting the collision resolution message, a collision resolution response message in association with the third cyclic shift range.

Aspect 17: The method of any of Aspects 1-16, further comprising: detecting a collision between the first communication path and the second communication path; and transmitting the first random access response message to the first UE and the second random access response message to the second UE simultaneously in association with detecting the collision.

Aspect 18: A method of wireless communication performed by a user equipment (UE), comprising: transmitting, to a network node, a random access preamble including a cyclic shift; receiving, from the network node, a random access response message indicating a cyclic shift range associated with a communication path of the UE; and transmitting a random access message in accordance with the cyclic shift range.

Aspect 19: The method of Aspect 18, wherein a round trip time associated with the communication path at least partially overlaps in a cyclic shift domain with a round trip time associated with a communication path of a second UE.

Aspect 20: The method of any of Aspects 18-19, wherein: the cyclic shift range includes one or more cyclic shifts that are each associated with a single communication path within a round trip time associated with the communication path.

Aspect 21: The method of any of Aspects 18-20, wherein receiving the random access response message is associated with a collision between the communication path and an additional communication path in accordance with a round trip time associated with the communication path at least partially overlapping in a cyclic shift domain with a round trip time associated with the additional communication path.

Aspect 22: The method of any of Aspects 18-21, wherein a collision between the communication path associated with the cyclic shift and an additional communication path associated with an additional cyclic shift is associated with a round trip time associated with the additional cyclic shift including the cyclic shift.

Aspect 23: The method of Aspect 22, further comprising: decoding the random access response message in accordance with an identifier associated with the random access response message, wherein the cyclic shift range includes the cyclic shift and the random access response message indicates a resource allocation; and calculating a timing advance for transmitting the random access message via the resource allocation, wherein the random access message includes a connection request message.

Aspect 24: The method of Aspect 22, further comprising: decoding the random access response message in accordance with an identifier associated with the random access response message, wherein the cyclic shift range excludes the cyclic shift; and monitoring for an additional random access response message.

Aspect 25: The method of any of Aspects 18-24, wherein the random access response message includes a resource allocation for communicating the random access message with the network node.

Aspect 26: The method of any of Aspects 18-25, wherein the random access response message includes one or more of: the cyclic shift range, an indication of the cyclic shift, a resource allocation for communicating the random access message, or a transmit power command associated with the cyclic shift.

Aspect 27: The method of any of Aspects 18-26, further comprising: receiving a collision resolution message indicating an additional cyclic shift range associated with a collision between the communication path and an additional communication path associated with a second UE.

Aspect 28: The method of Aspect 27, further comprising: decoding the collision resolution message in accordance with an identifier associated with the collision resolution message, wherein the collision resolution message indicates a resource allocation; and transmitting a collision resolution response message via the resource allocation in accordance with the additional cyclic shift range including the cyclic shift.

Aspect 29: The method of Aspect 27, further comprising: decoding the random access response message in accordance with an identifier associated with the random access response message, wherein the additional cyclic shift range excludes the cyclic shift; and transmitting an additional random access preamble including an additional cyclic shift.

Aspect 30: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-29.

Aspect 31: An apparatus for wireless communication at a device, the apparatus comprising one or more memories and one or more processors coupled to the one or more memories, the one or more processors configured to cause the device to perform the method of one or more of Aspects 1-29.

Aspect 32: An apparatus for wireless communication, the apparatus comprising at least one means for performing the method of one or more of Aspects 1-29.

Aspect 33: A non-transitory computer-readable medium storing code for wireless communication, the code comprising instructions executable by one or more processors to perform the method of one or more of Aspects 1-29.

Aspect 34: A non-transitory computer-readable medium storing a set of instructions for wireless communication, the set of instructions comprising one or more instructions that, when executed by one or more processors of a device, cause the device to perform the method of one or more of Aspects 1-29.

Aspect 35: A device for wireless communication, the device comprising a processing system that includes one or more processors and one or more memories coupled with the one or more processors, the processing system configured to cause the device to perform the method of one or more of Aspects 1-29.

Aspect 36: An apparatus for wireless communication at a device, the apparatus comprising one or more memories and one or more processors coupled to the one or more memories, the one or more processors individually or collectively configured to cause the device to perform the method of one or more of Aspects 1-29.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a network node, comprising:
one or more memories; and
one or more processors, coupled to the one or more memories, configured to cause the network node to:
receive, from a first user equipment (UE), a first random access preamble including a first cyclic shift, and from a second UE, a second random access preamble including a second cyclic shift;
transmit, to the first UE, a first random access response message including a first cyclic shift range in accordance with detecting a first communication path associated with the first cyclic shift and a second communication path associated with the second cyclic shift;
receive a random access message from the first UE in accordance with the first cyclic shift range; and
transmit, to the second UE, a second random access response message including a second cyclic shift range in accordance with receiving the random access message from the first UE.

2. The apparatus of claim 1, wherein the one or more processors are further configured to cause the network node to:
identify the first communication path associated with the first UE in association with receiving the first random access preamble; and
identify the second communication path associated with the second UE in association with receiving the second random access preamble, wherein a round trip time associated with the first communication path at least partially overlaps in a cyclic shift domain with a round trip time associated with the second communication path.

3. The apparatus of claim 1, wherein:
the first cyclic shift range includes one or more cyclic shifts that are each associated with a single communication path within a round trip time associated with the first communication path; and
the second cyclic shift range includes one or more cyclic shifts that are each associated with a single communication path within a round trip time associated with the second communication path.

4. The apparatus of claim 1, wherein the one or more processors are further configured to cause the network node to:
detect a collision between the first communication path and the second communication path in association with a round trip time associated with the first communication path at least partially overlapping in a cyclic shift domain with a round trip time associated with the second communication path, wherein transmitting the first random access response message and the second random access response message is associated with detecting the collision.

5. The apparatus of claim 1, wherein the one or more processors are further configured to cause the network node to:
detect a collision between the first communication path associated with the first cyclic shift and the second communication path associated with the second cyclic shift in accordance with receiving the first random access preamble and the second random access preamble, wherein the first cyclic shift is within a round trip time associated with the second cyclic shift.

6. The apparatus of claim 1, wherein the first random access response message includes a resource allocation for communicating the random access message with the first UE.

7. The apparatus of claim 1, wherein the first random access response message includes one or more of:
the first cyclic shift range,
an indication of the first cyclic shift,
a resource allocation for communicating the random access message, or
a transmit power command associated with the first cyclic shift.

8. The apparatus of claim 1, wherein the one or more processors are further configured to cause the network node to:
detect a collision between the first communication path and the second communication path; and
transmit the first random access response message to the first UE and transmitting the second random access response message to the second UE sequentially in association with detecting the collision.

9. The apparatus of claim 1, wherein the one or more processors are further configured to cause the network node to:
receive an additional random access message from the second UE in accordance with the second cyclic shift range.

10. The apparatus of claim 9, wherein the one or more processors are further configured to cause the network node to:
receive, from a third UE, a third random access preamble including a third cyclic shift associated with a third communication path, wherein a round trip time associated with the third communication path is disjoint from a round trip time associated with the first communication path and a round trip time associated with the second communication path; and
transmit, to the third UE, a random access response message.

11. The apparatus of claim 9, wherein the one or more processors are further configured to cause the network node to:
receive, from a third UE, a third random access preamble include a third cyclic shift associated with a third communication path, wherein a round trip time associated with the third communication path at least partially overlaps with at least one of a round trip time associated with the first communication path or a round trip time associated with the second communication path; and
transmit, to the third UE, a third random access message in accordance with receiving the random access message from the first UE and receiving the additional random access message from the second UE.

12. An apparatus for wireless communication at a user equipment (UE), comprising:
one or more memories; and
one or more processors, coupled to the one or more memories, configured to cause the UE to:
transmit, to a network node, a random access preamble including a cyclic shift;
receive, from the network node, a random access response message indicating a cyclic shift range associated with a communication path of the UE; and
transmit a random access message in accordance with the cyclic shift range.

13. The apparatus of claim 12, wherein a round trip time associated with the communication path at least partially overlaps in a cyclic shift domain with a round trip time associated with a communication path of a second UE.

14. The apparatus of claim 12, wherein:
the cyclic shift range includes one or more cyclic shifts that are each associated with a single communication path within a round trip time associated with the communication path.

15. The apparatus of claim 12, wherein receiving the random access response message is associated with a collision between the communication path and an additional communication path in accordance with a round trip time associated with the communication path at least partially overlapping in a cyclic shift domain with a round trip time associated with the additional communication path.

16. The apparatus of claim 12, wherein a collision between the communication path associated with the cyclic shift and an additional communication path associated with an additional cyclic shift is associated with a round trip time associated with the additional cyclic shift including the cyclic shift.

17. The apparatus of claim 16, wherein the one or more processors are further configured to cause the UE to:
decode the random access response message in accordance with an identifier associated with the random access response message, wherein the cyclic shift range includes the cyclic shift and the random access response message indicates a resource allocation; and
calculate a timing advance for transmitting the random access message via the resource allocation, wherein the random access message includes a connection request message.

18. The apparatus of claim 16, wherein the one or more processors are further configured to cause the UE to:
decode the random access response message in accordance with an identifier associated with the random access response message, wherein the cyclic shift range excludes the cyclic shift; and
monitor for an additional random access response message.

19. A method of wireless communication performed by a network node, comprising:
receiving, from a first user equipment (UE), a first random access preamble including a first cyclic shift, and from a second UE, a second random access preamble including a second cyclic shift;
transmitting, to the first UE, a first random access response message including a first cyclic shift range in accordance with detecting a first communication path associated with the first cyclic shift and a second communication path associated with the second cyclic shift;
receiving a random access message from the first UE in accordance with the first cyclic shift range; and
transmitting, to the second UE, a second random access response message including a second cyclic shift range in accordance with receiving the random access message from the first UE.

20. The method of claim 19, further comprising:
identifying an absence of an additional random access message in a set of random access resources allocated via the second random access response message; and
transmitting, to the second UE, a collision resolution message in accordance with receiving the random access message from the first UE and identifying the absence of the additional random access message from the second UE, wherein the collision resolution message indicates a third cyclic shift range associated with a collision between the first communication path and the second communication path.

21. The method of claim 20, further comprising:
receiving, according to the second cyclic shift and in association with transmitting the collision resolution message, a collision resolution response message in association with the third cyclic shift range including the second cyclic shift.

22. The method of claim 20, further comprising:
receiving, a random access preamble retransmission including a third cyclic shift in association with the third cyclic shift range excluding the second cyclic shift.

23. The method of claim 20, wherein the third cyclic shift range includes a range of cyclic shifts in a cyclic shift domain that includes the first communication path and the second communication path.

24. The method of claim 20, wherein the collision resolution message includes a resource allocation, the method further comprising:
receiving, via the resource allocation and in association with transmitting the collision resolution message, a collision resolution response message in association with the third cyclic shift range.

25. The method of claim 19, further comprising:
detecting a collision between the first communication path and the second communication path; and
transmitting the first random access response message to the first UE and the second random access response message to the second UE simultaneously in association with detecting the collision.

26. A method of wireless communication performed by a user equipment (UE), comprising:
transmitting, to a network node, a random access preamble including a cyclic shift;
receiving, from the network node, a random access response message indicating a cyclic shift range associated with a communication path of the UE; and
transmitting a random access message in accordance with the cyclic shift range.

27. The method of claim 26, wherein the random access response message includes a resource allocation for communicating the random access message with the network node.

28. The method of claim 26, further comprising:
receiving a collision resolution message indicating an additional cyclic shift range associated with a collision between the communication path and an additional communication path associated with a second UE.

29. The method of claim 28, further comprising:
decoding the collision resolution message in accordance with an identifier associated with the collision resolution message, wherein the collision resolution message indicates a resource allocation; and
transmitting a collision resolution response message via the resource allocation in accordance with the additional cyclic shift range including the cyclic shift.

30. The method of claim 28, further comprising:
decoding the random access response message in accordance with an identifier associated with the random access response message, wherein the additional cyclic shift range excludes the cyclic shift; and
transmitting an additional random access preamble including an additional cyclic shift.
